(19) United States
(12) Patent Application Publication
(10) Pub. No.: US 2023/0105632 A1
(43) Pub. Date: Apr. 6, 2023

(54) SIGNAL PROCESSING APPARATUS AND METHOD, AND PROGRAM

(71) Applicant: SONY GROUP CORPORATION, TOKYO (JP)

(72) Inventors: TAKAO FUKUI, TOKYO (JP); TORU CHINEN, TOKYO (JP)

(21) Appl. No.: 17/907,186

(22) PCT Filed: Mar. 19, 2021
(86) PCT No.: PCT/JP2021/011320

§ 371 Date: Sep. 23, 2022

(30) Foreign Application Priority Data
Apr. 1, 2020 (JP) 2020-065768

(51) Int. Cl. G10L 21/00

(52) U.S. Cl. CPC G10L 21/00

(57) ABSTRACT

The present technology relates to a signal processing apparatus and method, and a program that make it possible to obtain high-sound-quality signals even with a small processing amount. A signal processing apparatus includes a selecting section that is supplied with a plurality of audio signals and selects an audio signal to be subjected to a sound quality enhancement process, and a sound-quality-enhancement processing section that performs the sound quality enhancement process on the audio signal selected by the selecting section. The present technology may be applied to a portable terminal.

### TECHNICAL FIELD

The present technology relates to a signal processing apparatus and method, and a program, and particularly relates to a signal processing apparatus and method, and a program that make it possible to obtain high-sound-quality signals even with a small processing amount.

### BACKGROUND ART

In the past, as processes for sound quality enhancement of audio signals, that is, as processes for sound quality improvement, bandwidth expansion processes and dynamic range expansion processes have been known.

For example, as such a bandwidth expansion process, a technology in which, on the basis of low-frequency subband signals, filter coefficients of bandpass filters whose passbands are high-frequencies are calculated, and, by using the filter coefficients, filtering of flattened signals obtained from the low-frequency subband signals is performed to thereby generate high-frequency signals has been proposed (see PTL 1, for example).

### CITATION LIST

### Patent Literature

[PTL 1]

U.S. Pat. No. 9,922,660

### SUMMARY

### Technical Problem

Incidentally, if one attempts to perform a process for sound quality enhancement on object audio sounds including audio signals each corresponding to one of a plurality of objects such that the process is performed uniformly on the audio signals of all the objects, certainly the process needs to be performed a number of times that equals the number of objects.

Accordingly, for example, it becomes not possible for currently available platforms like smartphones, portable players, sound amplifiers, or the like to fully perform the process, in some cases.

For example, in a case where the number of objects is twelve which is relatively small, if one attempts to perform a sound quality enhancement process on all of the twelve objects, the processing amount becomes as enormous as 1 GCPS (cycles per second) to 3 GCPS undesirably.

The present technology has been made in view of such a situation, and aims to make it possible to obtain high-sound-quality signals even with a small processing amount.

### Solution to Problem

A signal processing apparatus according to one aspect of the present technology includes a selecting section that is supplied with a plurality of audio signals and selects an audio signal to be subjected to a sound quality enhancement process, and a sound-quality-enhancement processing section that performs the sound quality enhancement process on the audio signal selected by the selecting section.

A signal processing method or program according to one aspect of the present technology includes steps of being supplied with a plurality of audio signals, and selecting an audio signal to be subjected to a sound quality enhancement process, and performing the sound quality enhancement process on the selected audio signal.

In one aspect of the present technology, a plurality of audio signals is supplied, an audio signal to be subjected to a sound quality enhancement process is selected, and the sound quality enhancement process is performed on the selected audio signal.

### BRIEF DESCRIPTION OF DRAWINGS

FIG. 1 is a figure depicting a configuration example of a signal processing apparatus.

FIG. 2 is a figure depicting a configuration example of a sound-quality-enhancement processing section.

FIG. 3 is a figure depicting a configuration example of a dynamic range expanding section.

FIG. 4 is a figure depicting a configuration example of a bandwidth expanding section.

FIG. 5 is a figure depicting a configuration example of a dynamic range expanding section.

FIG. 6 is a figure depicting a configuration example of a bandwidth expanding section.

FIG. 7 is a figure depicting a configuration example of a bandwidth expanding section.

FIG. 8 is a flowchart for explaining a reproduction signal generation process.

FIG. 9 is a flowchart for explaining a high-load sound quality enhancement process.

FIG. 10 is a flowchart for explaining a mid-load sound quality enhancement process.

FIG. 11 is a flowchart for explaining a low-load sound quality enhancement process.

FIG. 12 is a figure depicting a configuration example of the signal processing apparatus.

FIG. 13 is a flowchart for explaining the reproduction signal generation process.

FIG. 14 is a figure depicting a configuration example of the signal processing apparatus.

FIG. 15 is a figure depicting a configuration example of the signal processing apparatus.

FIG. 16 is a flowchart for explaining the reproduction signal generation process.

FIG. 17 is a figure depicting a configuration example of a computer.

### DESCRIPTION OF EMBODIMENTS

Embodiments to which the present technology is applied are explained below with reference to the figures.

### First Embodiment

### <About Present Technology>

The present technology aims to make it possible to obtain high-sound-quality signals even with a small processing amount by selecting different processes as processes to be performed on audio signals by using metadata or the like in a case where sound quality enhancement of multi-channel audio sounds represented by object audio sounds is performed.

For example, in the present technology, for each audio signal, a sound quality enhancement process to be performed on the audio signal is selected on the basis of metadata or the like. In other words, audio signals to be subjected to sound quality enhancement processes are selected.

By doing so, it is possible to reduce a processing amount of processes for sound quality enhancement as a whole and obtain high-sound-quality signals even with a platform such as a portable terminal whose processing power is low.

In recent years, distribution of multi-channel audio sounds represented by object audio sounds has been planned. In such audio distribution, for example, the MPEG (Moving Picture Experts Group)-H format can be adopted.

For example, as sound quality enhancement processes on compressed signals (audio signals) in the MPEG-H format, dynamic range expansion processes and bandwidth expansion processes may be performed.

Here, dynamic range expansion processes are processes of expanding the dynamic range of an audio signal, that is, the bit count (quantization bit count) of a sample value of one sample of audio signals. In addition, bandwidth expansion processes are processes of adding a high-frequency component to an audio signal which does not include the high-frequency component.

Incidentally, it is not realistic to perform sound quality enhancement processes which require a high processing load, and further improve the sound quality of all of a plurality of audio signals.

In view of this, for example, the present technology makes it possible to perform more appropriate sound quality improvement by performing, on the basis of metadata of audio signals or the like, a sound quality enhancement process which requires a high processing load but provides a higher sound quality improvement effect on important audio signals, and performing a sound quality enhancement process which requires a lower processing load on less important audio signals. That is, it is made possible to obtain signals with sufficiently high sound quality even with a small processing amount.

Note that audio signals to be the subjects of sound quality enhancement may be any audio signals, but an explanation is given below supposing that multiple audio signals included in a predetermined content are the subjects of sound quality enhancement.

In addition, it is supposed that the multiple audio signals included in the content which are the subjects of sound quality enhancement include audio signals of channels such as R or L, and audio signals of audio objects (hereinafter, simply referred to as objects) such as vocal sounds.

Furthermore, it is supposed that each audio signal has metadata added thereto, and the metadata includes type information and priority information. In addition, it is supposed that metadata of audio signals of objects also includes positional information representing the positions of the objects.

Type information is information representing the types of audio signals, that is, for example, the channel names of audio signals such as L or R, or the types of objects such as vocal or guitar, more specifically the types of sound sources of the objects.

It is supposed that priority information is information representing the priorities (priorities) of audio signals, and the priorities are represented here by numerical values from 1 to 10. Specifically, it is supposed that the smaller the numerical value representing a priority is, the higher the priority is. Accordingly, in this example, the priority “1” is the highest priority, and the priority “10” is the lowest priority.

Furthermore, in an example explained below, three mutually different sound quality enhancement processes which are a high-load sound quality enhancement process, a mid-load sound quality enhancement process, and a low-load sound quality enhancement process are prepared in advance as sound quality enhancement processes. Then, on the basis of metadata, a sound quality enhancement process to be performed on an audio signal is selected from the sound quality enhancement processes.

The high-load sound quality enhancement process is a sound quality enhancement process that requires the highest processing load of the three sound quality enhancement processes but provides the highest sound quality improvement effect, and is particularly useful as a sound quality enhancement process on audio signals of high priority or audio signals of types of high importance.

As a specific example of the high-load sound quality enhancement process, for example, a dynamic range expansion process and a bandwidth expansion process based on a DNN (Deep Neural Network) or the like obtained in advance by machine learning may be performed in combination.

The low-load sound quality enhancement process is a sound quality enhancement process that requires the lowest processing load of the three sound quality enhancement processes and provides the lowest sound quality improvement effect, and is particularly useful as a sound quality enhancement process on audio signals of low priority or of types of low importance.

As a specific example of the low-load sound quality enhancement process, for example, processes that require extremely low loads such as a bandwidth expansion process using a predetermined coefficient or a coefficient specified on the encoding side, a simplified bandwidth expansion process of adding signals such as white noise as high-frequency components to audio signals, or a dynamic range expansion process by filtering using a predetermined coefficient may be performed in combination.

The mid-load sound quality enhancement process is a sound quality enhancement process that requires the second highest processing load of the three sound quality enhancement processes and also provides the second highest sound quality improvement effect, and is particularly useful as a sound quality enhancement process on audio signals of intermediate priorities or of types of intermediate importance.

As a specific example of the mid-load sound quality enhancement process, for example, a bandwidth expansion process of generating high-frequency components by linear prediction, a dynamic range expansion process by filtering using a predetermined coefficient, and the like may be performed in combination.

Note that, whereas the number of processes as mutually different sound quality enhancement processes is three in examples explained below, the number of mutually different sound quality enhancement processes may be any number which is two or larger. In addition, the sound quality enhancement processes are not limited to dynamic range expansion processes or bandwidth expansion processes. Other processes may be performed, or only either dynamic range expansion processes or bandwidth expansion processes may be performed.

Here, specific examples are explained. For example, it is supposed that as audio signals to be the subjects of sound quality enhancement, there are audio signals of eight objects OB1 to OB7.

In addition, the type and priority of each object are written as (type, priority).

It is supposed now that the types and priorities represented by metadata of the object OB1 to the object OB7 are (vocal, 1), (drums, 1), (guitar, 2), (bass, 3), (reverberation, 9), (audience, 10), and (environmental sound, 10), respectively.

At this time, for example, at a platform having typical processing power, the high-load sound quality enhancement process is performed on the audio signals of the object OB1 and the object OB2 whose priorities are the highest “1.” In addition, the mid-load sound quality enhancement process is performed on the audio signals of the object OB3 and the object OB4 whose priorities are “2” and “3,” and the low-load sound quality enhancement process is performed on the audio signals of the other objects, the object OB5 to the object OB7, whose priorities are low.

In contrast to this, at reproducing equipment (platform) that has high processing power, and can perform a larger number of processes for sound quality improvement, the high-load sound quality enhancement process is performed on audio signals of a larger number of objects than in the example mentioned before.

For example, it is supposed that the types and priorities represented by metadata of the object OB1 to the object OB7 are (vocal, 1), (drums, 2), (guitar, 2), (bass, 3), (reverberation, 9), (audience, 10), and (environmental sound, 10), respectively.

At this time, the high-load sound quality enhancement process is performed on the audio signals of the object OB1 to the object OB3 with high priorities “1” and “2,” and the mid-load sound quality enhancement process is performed on the audio signals of the object OB4 and the object OB5 with priorities “3” and “9.” Then, the low-load sound quality enhancement process is performed on only the audio signals of the object OB6 and the object OB7 with the lowest priority “10.”

In addition, at a platform having processing power lower than typical processing power, the high-load sound quality enhancement process is performed on fewer audio signals than in the two examples mentioned before, and sound quality enhancement is performed more efficiently.

For example, it is supposed that the types and priorities represented by metadata of the object OB1 to the object OB7 are (vocal, 1), (drums, 2), (guitar, 2), (bass, 3), (reverberation, 9), (audience, 10), and (environmental sound, 10), respectively.

At this time, the high-load sound quality enhancement process is performed on only the audio signal of the object OB1 with the highest priority “1,” and the mid-load sound quality enhancement process is performed on the audio signals of the object OB2 and the object OB3 with the priority “2.” Then, the low-load sound quality enhancement process is performed on the audio signals of the object OB4 to the object OB7 with priorities equal to or lower than “3.”

As mentioned above, in the present technology, on the basis of at least either priority information or type information included in metadata, a sound quality enhancement process to be performed on each audio signal is selected. By doing so, for example, according to the processing power of reproducing equipment (platform), it is possible to set the overall processing load at a time of sound quality enhancement to be executed, and to perform sound quality enhancement, that is, sound quality improvement, at any type of reproducing equipment.

### <Configuration Example of Signal Processing Apparatus>

Next, more specific embodiments of the present technology explained above are explained.

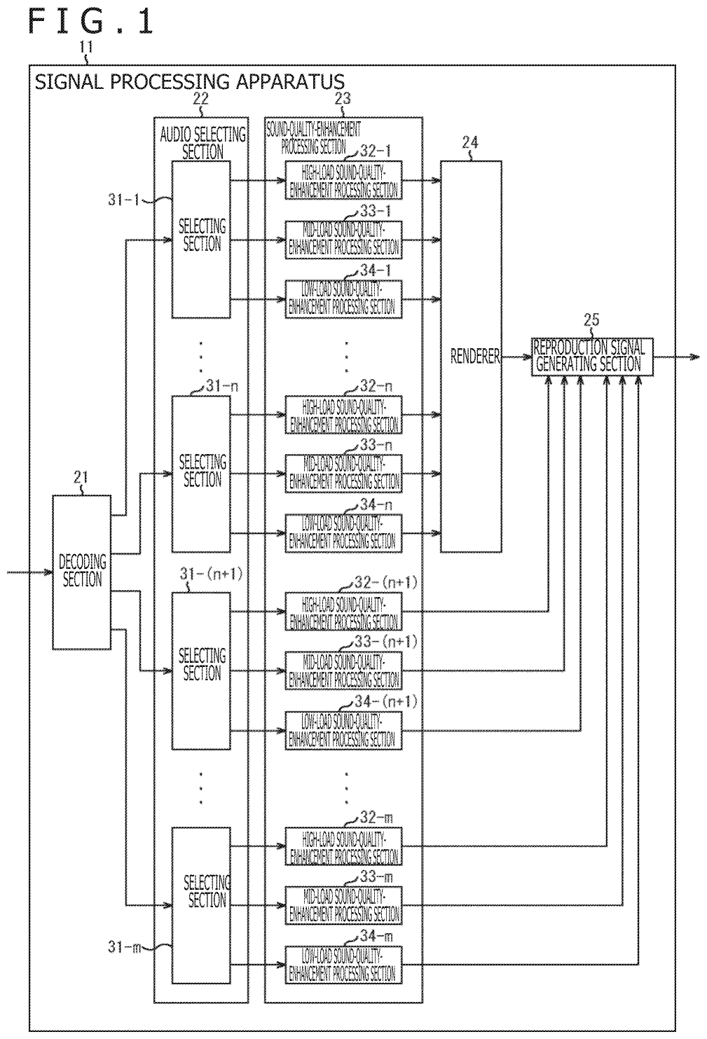

FIG. 1 is a figure depicting a configuration example of one embodiment of a signal processing apparatus to which the present technology is applied.

For example, a signal processing apparatus 11 depicted in FIG. 1 includes a smartphone, a portable player, a sound amplifier, a personal computer, a tablet, or the like.

The signal processing apparatus 11 has a decoding section 21, an audio selecting section 22, a sound-quality-enhancement processing section 23, a renderer 24, and a reproduction signal generating section 25.

For example, the decoding section 21 is supplied with a plurality of audio signals, and encoded data obtained by encoding metadata of the audio signals. For example, the encoded data is a bitstream or the like in a predetermined encoding format such as MPEG-H.

The decoding section 21 performs a decoding process on the supplied encoded data, and supplies audio signals obtained thereby and metadata of the audio signals to the audio selecting section 22.

For each of the plurality of audio signals supplied from the decoding section 21, and on the basis of the metadata supplied from the decoding section 21, the audio selecting section 22 selects a sound quality enhancement process to be performed on the audio signal, and supplies the audio signal to the sound-quality-enhancement processing section 23 according to a result of the selection.

In other words, the audio selecting section 22 is supplied with the plurality of audio signals from the decoding section 21, and also, on the basis of the metadata, selects audio signals to be subjected to sound quality enhancement processes such as the high-load sound quality enhancement process.

The audio selecting section 22 has a selecting section 31-1 to a selecting section 31-m, and each of the selecting section 31-1 to the selecting section 31-m is supplied with one audio signal and metadata of the audio signal.

In particular, in this example, the encoded data includes, as audio signals to be the subjects of sound quality enhancement, audio signals of n objects, and audio signals of (m-n) channels. Then, the selecting section 31-1 to the selecting section 31-n are supplied with the audio signals of the objects, and their metadata, and the selecting section 31-(n+1) to the selecting section 31-m are supplied with the audio signals of the channels, and their metadata.

On the basis of the metadata supplied from the decoding section 21, the selecting section 31-1 to the selecting section 31-m select sound quality enhancement processes to be performed on the audio signals supplied from the decoding section 21, that is, blocks to which the audio signals are output, and supply the audio signals to blocks in the sound-quality-enhancement processing section 23 according to results of the selection.

In addition, the selecting section 31-1 to the selecting section 31-n supply, to the renderer 24 via the sound-quality-enhancement processing section 23, the metadata of the audio signals of the objects supplied from the decoding section 21.

Note that, in a case where it is not particularly necessary to make distinctions among the selecting section 31-1 to the selecting section 31-m below, they are also referred to as selecting sections 31 simply.

On each audio signal supplied from the audio selecting section 22, the sound-quality-enhancement processing section 23 performs any of three types of predetermined sound quality enhancement process, and outputs an audio signal obtained thereby as high-sound-quality signals. The three types of sound quality enhancement process mentioned here are the high-load sound quality enhancement process, mid-load sound quality enhancement process, and low-load sound quality enhancement process mentioned above.

The sound-quality-enhancement processing section 23 has a high-load sound-quality-enhancement processing section 32-1 to a high-load sound-quality-enhancement processing section 32-m, a mid-load sound-quality-enhancement processing section 33-1 to a mid-load sound-quality-enhancement processing section 33-m, and a low-load sound-quality-enhancement processing section 34-1 to a low-load sound-quality-enhancement processing section 34-m.

In a case where audio signals are supplied from the selecting section 31-1 to the selecting section 31-m, the high-load sound-quality-enhancement processing section 32-1 to the high-load sound-quality-enhancement processing section 32-m perform the high-load sound quality enhancement process on the supplied audio signals, and generate high-sound-quality signals.

The high-load sound-quality-enhancement processing section 32-1 to the high-load sound-quality-enhancement processing section 32-n supply, to the renderer 24, the high-sound-quality signals of the objects obtained by the high-load sound quality enhancement process.

In addition, the high-load sound-quality-enhancement processing section 32-(n+1) to the high-load sound-quality-enhancement processing section 32-m supply, to the reproduction signal generating section 25, the high-sound-quality signals of the channels obtained by the high-load sound quality enhancement process.

Note that, in a case where it is not particularly necessary to make distinctions among the high-load sound-quality-enhancement processing section 32-1 to the high-load sound-quality-enhancement processing section 32-m below, they are also referred to as high-load sound-quality-enhancement processing sections 32 simply.

In a case where audio signals are supplied from the selecting section 31-1 to the selecting section 31-m, the mid-load sound-quality-enhancement processing section 33-1 to the mid-load sound-quality-enhancement processing section 33-m perform the mid-load sound quality enhancement process on the supplied audio signals, and generate high-sound-quality signals.

The mid-load sound-quality-enhancement processing section 33-1 to the mid-load sound-quality-enhancement processing section 33-n supply, to the renderer 24, the high-sound-quality signals of the objects obtained by the mid-load sound quality enhancement process.

In addition, the mid-load sound-quality-enhancement processing section 33-(n+1) to the mid-load sound-quality-enhancement processing section 33-m supply, to the reproduction signal generating section 25, the high-sound-quality signals of the channels obtained by the mid-load sound quality enhancement process.

Note that, in a case where it is not particularly necessary to make distinctions among the mid-load sound-quality-enhancement processing section 33-1 to the mid-load sound-quality-enhancement processing section 33-m below, they are also referred to as mid-load sound-quality-enhancement processing sections 33 simply.

In a case where audio signals are supplied from the selecting section 31-1 to the selecting section 31-m, the low-load sound-quality-enhancement processing section 34-1 to the low-load sound-quality-enhancement processing section 34-m perform the low-load sound quality enhancement process on the supplied audio signals, and generate high-sound-quality signals.

The low-load sound-quality-enhancement processing section 34-1 to the low-load sound-quality-enhancement processing section 34-n supply, to the renderer 24, the high-sound-quality signals of the objects obtained by the low-load sound quality enhancement process.

In addition, the low-load sound-quality-enhancement processing section 34-(n+1) to the low-load sound-quality-enhancement processing section 34-m supply, to the reproduction signal generating section 25, the high-sound-quality signals of the channels obtained by the low-load sound quality enhancement process.

Note that, in a case where it is not particularly necessary to make distinctions among the low-load sound-quality-enhancement processing section 34-1 to the low-load sound-quality-enhancement processing section 34-m below, they are also referred to as low-load sound-quality-enhancement processing sections 34 simply.

On the basis of the metadata supplied from the sound-quality-enhancement processing section 23, the renderer 24 performs a rendering process according to reproducing equipment such as speakers on the downstream side on the high-sound-quality signals of the objects supplied from the high-load sound-quality-enhancement processing sections 32, the mid-load sound-quality-enhancement processing sections 33, and the low-load sound-quality-enhancement processing sections 34.

For example, at the renderer 24, VBAP (Vector Based Amplitude Panning) is performed as the rendering process, and an object reproduction signal that locates the sound of each object at a position represented by positional information included in the metadata of the object is obtained. The object reproduction signals are multi-channel audio signals including audio signals of the (m-n) channels.

The renderer 24 supplies the object reproduction signals obtained by the rendering process to the reproduction signal generating section 25.

The reproduction signal generating section 25 performs a synthesis process of synthesizing the object reproduction signals supplied from the renderer 24, and the high-sound-quality signals of the channels supplied from the high-load sound-quality-enhancement processing sections 32, the mid-load sound-quality-enhancement processing sections 33, and the low-load sound-quality-enhancement processing sections 34.

For example, in the synthesis process, an object reproduction signal and high-sound-quality signal of the same channel are added together (synthesized), and reproduction signals of the (m-n) channels are generated. If these reproduction signals are reproduced at (m-n) speakers, a sound of each channel or a sound of each object, that is, a sound of a content, is reproduced.

The reproduction signal generating section 25 outputs the reproduction signals obtained by the synthesis process to the downstream side.

### <Configuration Example of Sound-Quality-Enhancement Processing Sections>

Next, configuration examples of the high-load sound-quality-enhancement processing sections 32, the mid-load sound-quality-enhancement processing sections 33, and the low-load sound-quality-enhancement processing sections 34 are explained.

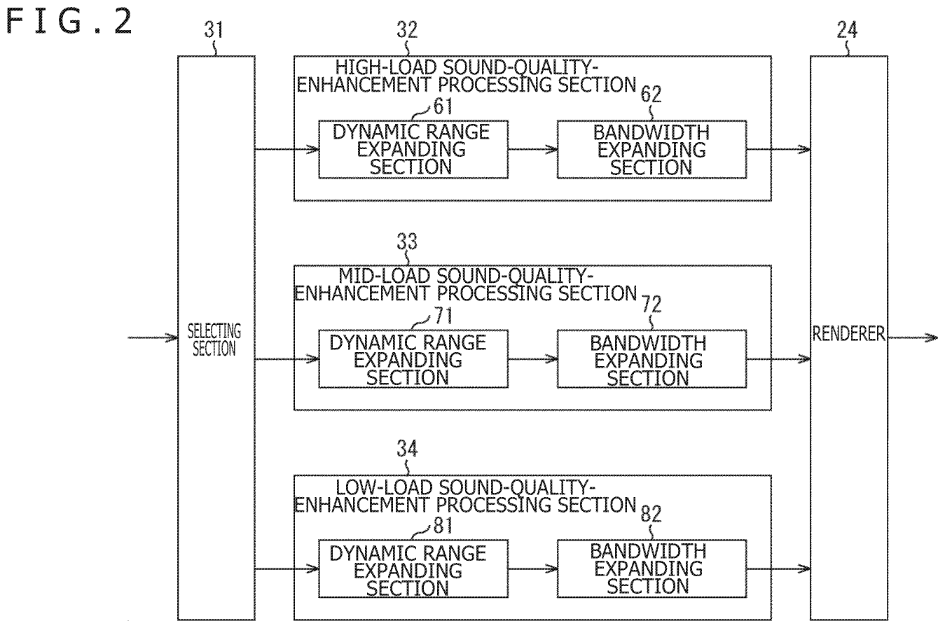

For example, the high-load sound-quality-enhancement processing sections 32, the mid-load sound-quality-enhancement processing sections 33, and the low-load sound-quality-enhancement processing sections 34 are configured as depicted in FIG. 2. Note that FIG. 2 depicts an example in which the renderer 24 is provided on the downstream side of a high-load sound-quality-enhancement processing section 32 to a low-load sound-quality-enhancement processing section 34.

In the example depicted in FIG. 2, the high-load sound-quality-enhancement processing section 32 has a dynamic range expanding section 61 and a bandwidth expanding section 62.

On an audio signal supplied from a selecting section 31, the dynamic range expanding section 61 performs a dynamic range expansion process based on a DNN generated in advance by machine learning, and supplies an audio signal obtained thereby to the bandwidth expanding section 62.

On the audio signal supplied from the dynamic range expanding section 61, the bandwidth expanding section 62 performs a bandwidth expansion process based on a DNN generated in advance by machine learning, and supplies a high-sound-quality signal obtained thereby to the renderer 24.

The mid-load sound-quality-enhancement processing section 33 has a dynamic range expanding section 71 and a bandwidth expanding section 72.

On an audio signal supplied from the selecting section 31, the dynamic range expanding section 71 performs a dynamic range expansion process by all-pass filters at multiple stages, and supplies an audio signal obtained thereby to the bandwidth expanding section 72.

On the audio signal supplied from the dynamic range expanding section 71, the bandwidth expanding section 72 performs a bandwidth expansion process using linear prediction, and supplies a high-sound-quality signal obtained thereby to the renderer 24.

Furthermore, the low-load sound-quality-enhancement processing section 34 has a dynamic range expanding section 81 and a bandwidth expanding section 82.

On an audio signal supplied from the selecting section 31, the dynamic range expanding section 81 performs a dynamic range expansion process similar to that performed in the case of the dynamic range expanding section 71, and supplies an audio signal obtained thereby to the bandwidth expanding section 82.

On the audio signal supplied from the dynamic range expanding section 81, the bandwidth expanding section 82 performs a bandwidth expansion process using a coefficient specified on the encoding side, and supplies a high-sound-quality signal obtained thereby to the renderer 24.

### <Configuration Example of Dynamic Range Expanding Sections>

Furthermore, configuration examples of the dynamic range expanding section 61, the bandwidth expanding section 62, and the like depicted in FIG. 2 are explained below.

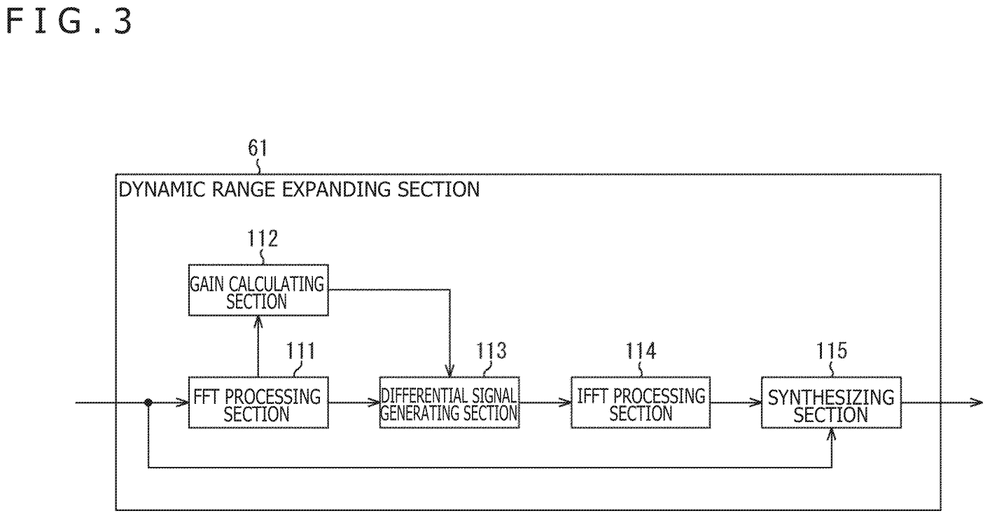

FIG. 3 is a figure depicting a more detailed configuration example of the dynamic range expanding section 61.

The dynamic range expanding section 61 depicted in FIG. 3 has a FFT (Fast Fourier Transform) processing section 111, a gain calculating section 112, a differential signal generating section 113, an IFFT (Inverse Fast Fourier Transform) processing section 114, and a synthesizing section 115.

At the dynamic range expanding section 61, a differential signal which is a difference between an audio signal obtained by decoding at the decoding section 21, and an original-sound signal before encoding of the audio signal is predicted by a prediction computation using a DNN, and the differential signal and the audio signal are synthesized. By doing so, a high-sound-quality audio signal closer to the original-sound signal can be obtained.

The FFT processing section 111 performs a FFT on the audio signal supplied from the selecting section 31, and supplies a signal obtained thereby to the gain calculating section 112 and the differential signal generating section 113.

The gain calculating section 112 includes the DNN obtained in advance by machine learning. That is, the gain calculating section 112 retains prediction coefficients that are obtained in advance by machine learning, and used for computations in the DNN, and functions as a predictor that predicts the envelope of frequency characteristics of the differential signal.

On the basis of the retained prediction coefficients, and the signal supplied from the FFT processing section 111, the gain calculating section 112 calculates a gain value as a parameter for generating the differential signal corresponding to the audio signal, and supplies the gain value to the differential signal generating section 113. That is, as a parameter for generating the differential signal, a gain of the frequency envelope of the differential signal is calculated.

On the basis of the signal supplied from the FFT processing section 111, and the gain value supplied from the gain calculating section 112, the differential signal generating section 113 generates the differential signal, and supplies the differential signal to the IFFT processing section 114. On the differential signal supplied from the differential signal generating section 113, the IFFT processing section 114 performs an IFFT, and supplies a differential signal in the time domain obtained thereby to the synthesizing section 115.

The synthesizing section 115 synthesizes the audio signal supplied from the selecting section 31, and the differential signal supplied from the IFFT processing section 114, and supplies an audio signal obtained thereby to the bandwidth expanding section 62.

### <Configuration Example of Bandwidth Expanding Sections>

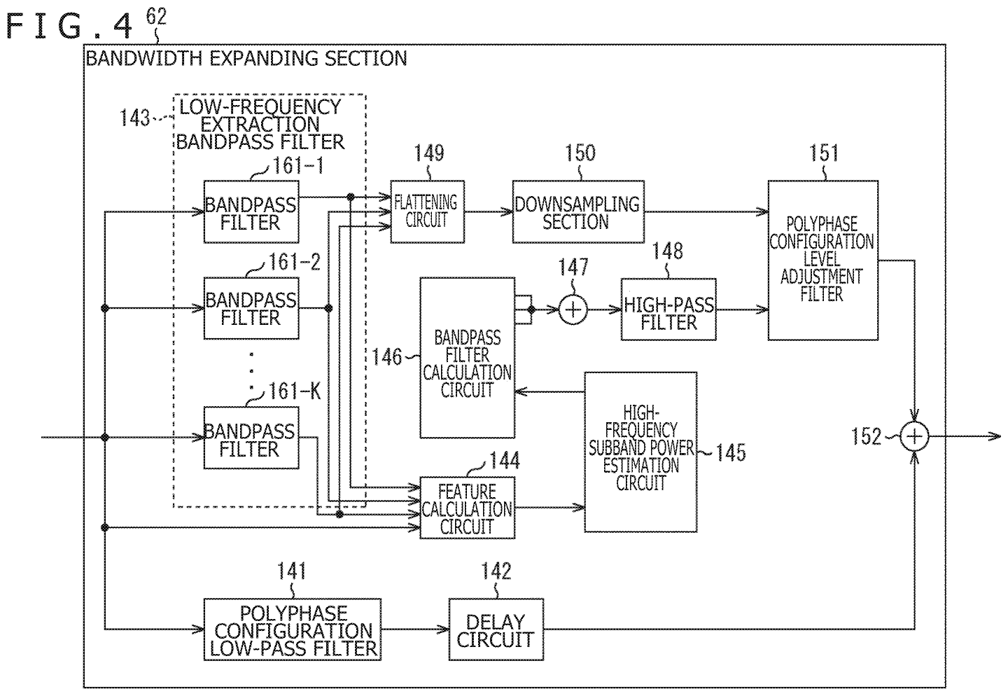

In addition, the bandwidth expanding section 62 depicted in FIG. 2 is configured as depicted in FIG. 4, for example.

The bandwidth expanding section 62 depicted in FIG. 4 has a polyphase configuration low-pass filter 141, a delay circuit 142, a low-frequency extraction bandpass filter 143, a feature calculation circuit 144, a high-frequency subband power estimation circuit 145, a bandpass filter calculation circuit 146, an adding section 147, a high-pass filter 148, a flattening circuit 149, a downsampling section 150, a polyphase configuration level adjustment filter 151, and an adding section 152.

On the audio signal supplied from the synthesizing section 115 of the dynamic range expanding section 61, the polyphase configuration low-pass filter 141 performs filtering with a low-pass filter with polyphase configuration, and supplies a low-frequency signal obtained thereby to the delay circuit 142.

At the polyphase configuration low-pass filter 141, by the filtering with the low-pass filter with polyphase configuration, upsampling and extraction of a low-frequency component of the signal are performed, and the low-frequency signal is obtained.

The delay circuit 142 delays the low-frequency signal supplied from the polyphase configuration low-pass filter 141 by a certain length of delay time, and supplies the low-frequency signal to the adding section 152.

The low-frequency extraction bandpass filter 143 includes a bandpass filter 161-1 to a bandpass filter 161-K having mutually different passbands.

A bandpass filter 161-k (n.b. 1≤k≤K) allows passage therethrough of signals in a subband which is a predetermined passband on the low-frequency side in the audio signal supplied from the synthesizing section 115, and supplies signals in the predetermined band obtained thereby to the feature calculation circuit 144 and the flattening circuit 149 as low-frequency subband signals. Accordingly, at the low-frequency extraction bandpass filter 143, low-frequency subband signals in K subbands included in the low-frequencies are obtained.

Note that, in a case where it is not particularly necessary to make distinctions among the bandpass filter 161-1 to the bandpass filter 161-K below, they are also referred to as bandpass filters 161 simply.

On the basis of a plurality of the low-frequency subband signals supplied from the bandpass filters 161 or the audio signal supplied from the synthesizing section 115, the feature calculation circuit 144 calculates features and supplies the features to the high-frequency subband power estimation circuit 145.

The high-frequency subband power estimation circuit 145 includes a DNN obtained in advance by machine learning. That is, the high-frequency subband power estimation circuit 145 retains prediction coefficients that are obtained in advance by machine learning, and used for computations in the DNN.

On the basis of the retained prediction coefficients, and the features supplied from the feature calculation circuit 144, the high-frequency subband power estimation circuit 145 calculates, for each of high-frequency subbands, an estimated value of high-frequency subband power which is the power of a high-frequency subband signal, and supplies the estimated value to the bandpass filter calculation circuit 146. The estimated value of the high-frequency subband power is also referred to as pseudo high-frequency subband power below.

On the basis of the pseudo high-frequency subband power of a plurality of the high-frequency subbands supplied from the high-frequency subband power estimation circuit 145, the bandpass filter calculation circuit 146 calculates bandpass filter coefficients of bandpass filters whose passbands are the high-frequency subbands and supplies the bandpass filter coefficients to the adding section 147.

The adding section 147 adds together the bandpass filter coefficients supplied from the bandpass filter calculation circuit 146 into one filter coefficient and supplies the filter coefficient to the high-pass filter 148.

By performing filtering of the filter coefficient supplied from the adding section 147 using a high-pass filter, the high-pass filter 148 removes low-frequency components from the filter coefficient and supplies a filter coefficient obtained thereby to the polyphase configuration level adjustment filter 151. That is, the high-pass filter 148 allows passage therethrough of only a high-frequency component of the filter coefficient.

By flattening and adding together low-frequency subband signals in a plurality of low-frequency subbands supplied from the bandpass filters 161, the flattening circuit 149 generates a flattened signal and supplies the flattened signal to the downsampling section 150.

The downsampling section 150 performs downsampling on the flattened signal supplied from the flattening circuit 149 and supplies the downsampled flattened signal to the polyphase configuration level adjustment filter 151.

By performing filtering using the filter coefficient supplied from the high-pass filter 148 on the flattened signal supplied from the downsampling section 150, the polyphase configuration level adjustment filter 151 generates a high-frequency signal and supplies the high-frequency signal to the adding section 152.

The adding section 152 adds together the low-frequency signal supplied from the delay circuit 142, and the high-frequency signal supplied from the polyphase configuration level adjustment filter 151 into a high-sound-quality signal and supplies the high-sound-quality signal to the renderer 24 or the reproduction signal generating section 25.

The high-frequency signal obtained at the polyphase configuration level adjustment filter 151 is a high-frequency-component signal not included in the original audio signal, that is, for example, a high-frequency-component signal that has undesirably been lost at a time of encoding of the audio signal. Accordingly, by synthesizing such a high-frequency signal with a low-frequency signal which is a low-frequency component of the original audio signal, a signal including components in a wider frequency band, that is, a high-sound-quality signal with higher sound quality, can be obtained.

### <Configuration Example of Dynamic Range Expanding Sections>

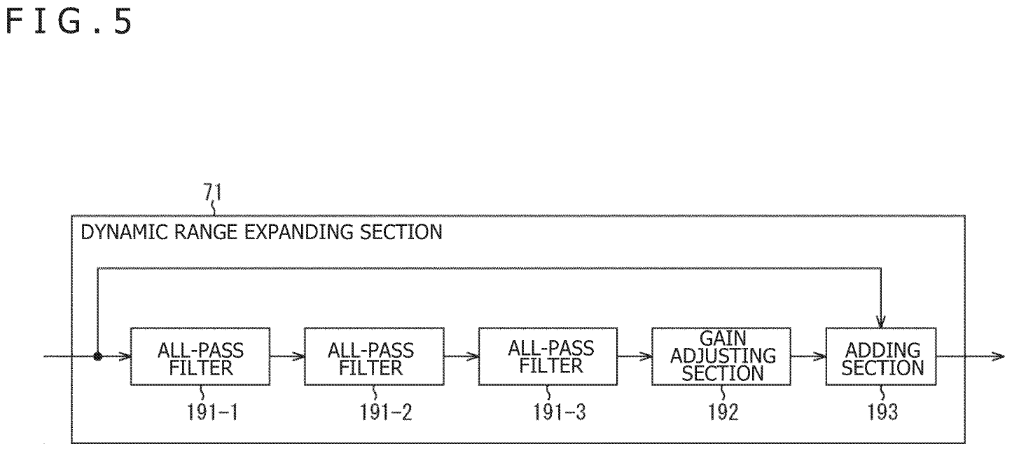

In addition, the dynamic range expanding section 71 of the mid-load sound-quality-enhancement processing section 33 depicted in FIG. 2 is configured as depicted in FIG. 5, for example.

The dynamic range expanding section 71 depicted in FIG. 5 has an all-pass filter 191-1 to an all-pass filter 191-3, a gain adjusting section 192, and an adding section 193. In this example, the three all-pass filter 191-1 to all-pass filter 191-3 are connected in a cascade.

The all-pass filter 191-1 performs filtering on an audio signal supplied from the selecting section 31 and supplies an audio signal obtained thereby to the all-pass filter 191-2 on the downstream side.

On the audio signal supplied from the all-pass filter 191-1, the all-pass filter 191-2 performs filtering, and supplies an audio signal obtained thereby to the all-pass filter 191-3 on the downstream side.

On the audio signal supplied from the all-pass filter 191-2, the all-pass filter 191-3 performs filtering, and supplies an audio signal obtained thereby to the gain adjusting section 192.

Note that, in a case where it is not particularly necessary to make distinctions among the all-pass filter 191-1 to the all-pass filter 191-3 below, they are also referred to as all-pass filters 191 simply.

On the audio signal supplied from the all-pass filter 191-3, the gain adjusting section 192 performs gain adjustment, and supplies the audio signal after the gain adjustment to the adding section 193.

By adding together the audio signal supplied from the gain adjusting section 192 and the audio signal supplied from the selecting section 31, the adding section 193 generates an audio signal with enhanced sound quality, that is, whose dynamic range has been expanded, and supplies the audio signal to the bandwidth expanding section 72.

Because processes performed at the dynamic range expanding section 71 are filtering and gain adjustment, the processes can be achieved with a processing load smaller (lower) than in computation processes in a DNN like those performed at the dynamic range expanding section 61 depicted in FIG. 3.

### <Configuration Example of Bandwidth Expanding Sections>

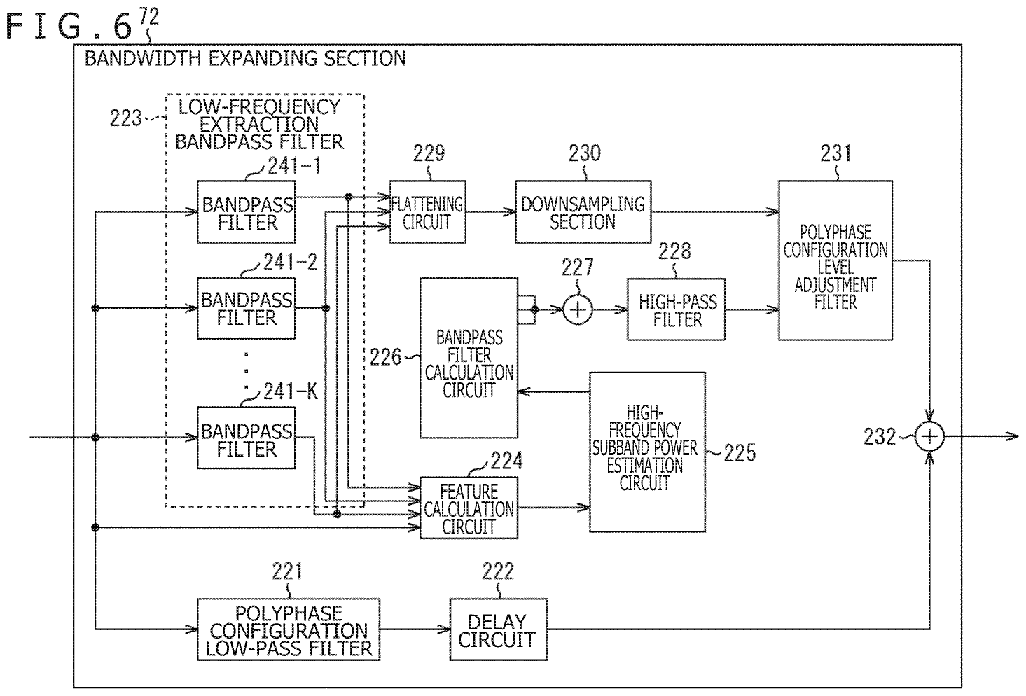

Furthermore, the bandwidth expanding section 72 depicted in FIG. 2 is configured as depicted in FIG. 6, for example.

The bandwidth expanding section 72 depicted in FIG. 6 has a polyphase configuration low-pass filter 221, a delay circuit 222, a low-frequency extraction bandpass filter 223, a feature calculation circuit 224, a high-frequency subband power estimation circuit 225, a bandpass filter calculation circuit 226, an adding section 227, a high-pass filter 228, a flattening circuit 229, a downsampling section 230, a polyphase configuration level adjustment filter 231, and an adding section 232.

In addition, the low-frequency extraction bandpass filter 223 has a bandpass filter 241-1 to a bandpass filter 241-K.

Note that, because the polyphase configuration low-pass filter 221 to the feature calculation circuit 224, and the bandpass filter calculation circuit 226 to the adding section 232 have the same configuration, and perform the same operation as those of the polyphase configuration low-pass filter 141 to feature calculation circuit 144, and bandpass filter calculation circuit 146 to adding section 152 of the bandwidth expanding section 62 depicted in FIG. 4, explanations thereof are omitted.

In addition, because the bandpass filter 241-1 to the bandpass filter 241-K also have the same configuration, and perform the same operation as those of the bandpass filter 161-1 to bandpass filter 161-K of the bandwidth expanding section 62 depicted in FIG. 4, explanations thereof are omitted.

Note that, in a case where it is not particularly necessary to make distinctions among the bandpass filter 241-1 to the bandpass filter 241-K below, they are also referred to as bandpass filters 241 simply.

The bandwidth expanding section 72 depicted in FIG. 6 is different from the bandwidth expanding section 62 depicted in FIG. 4 in terms only of operation in the high-frequency subband power estimation circuit 225 and is the same as the bandwidth expanding section 62 in terms of configuration and operation in other respects.

The high-frequency subband power estimation circuit 225 retains coefficients that are obtained in advance by statistical learning, and, on the basis of the retained coefficients, and features supplied from the feature calculation circuit 224, calculates pseudo high-frequency subband power, and supplies the pseudo high-frequency subband power to the bandpass filter calculation circuit 226. For example, at the high-frequency subband power estimation circuit 225, by linear prediction using the retained coefficients, a high-frequency component, more specifically pseudo high-frequency subband power, is calculated.

The linear prediction at the high-frequency subband power estimation circuit 225 can be achieved with a smaller processing load, as compared to the prediction by computations in the DNN at the high-frequency subband power estimation circuit 145.

### <Configuration Example of Bandwidth Expanding Sections>

In addition, the dynamic range expanding section 81 of the low-load sound-quality-enhancement processing section 34 depicted in FIG. 2 has the same configuration as the dynamic range expanding section 71 depicted in FIG. 5, for example. Note that the dynamic range expanding section 81 may not be provided particularly in the low-load sound-quality-enhancement processing section 34.

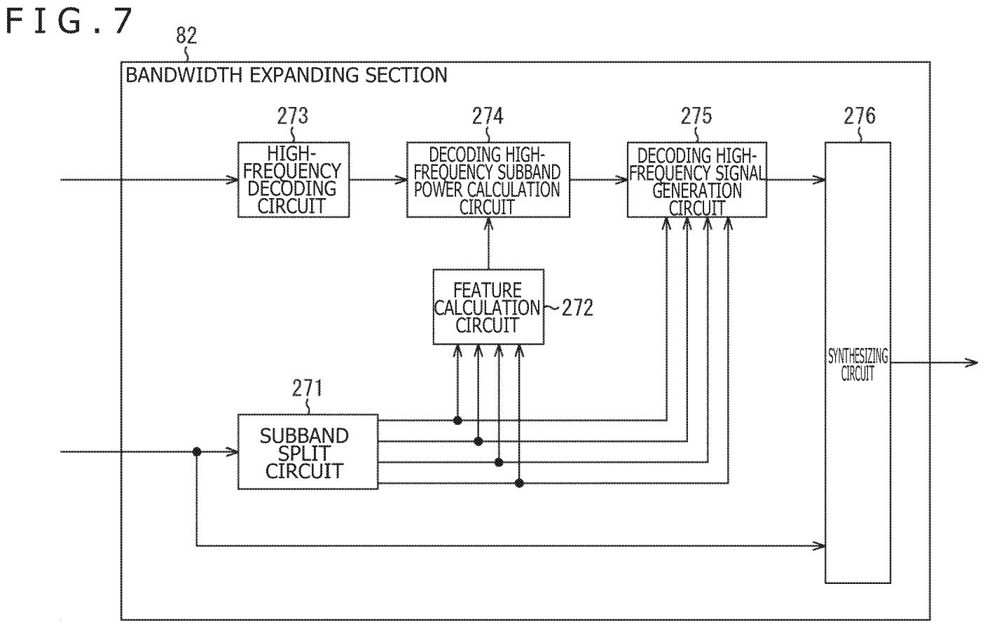

Furthermore, the bandwidth expanding section 82 of the low-load sound-quality-enhancement processing section 34 depicted in FIG. 2 is configured as depicted in FIG. 7, for example.

The bandwidth expanding section 82 depicted in FIG. 7 has a subband split circuit 271, a feature calculation circuit 272, a high-frequency decoding circuit 273, a decoding high-frequency subband power calculation circuit 274, a decoding high-frequency signal generation circuit 275, and a synthesizing circuit 276.

Note that, in a case where the bandwidth expanding section 82 has the configuration depicted in FIG. 7, encoded data supplied to the decoding section 21 includes high-frequency encoded data, and the high-frequency encoded data is supplied to the high-frequency decoding circuit 273. The high-frequency encoded data is data obtained by encoding indices for obtaining a high-frequency subband power estimation coefficient mentioned later.

The subband split circuit 271 evenly splits an audio signal supplied from the dynamic range expanding section 81 into a plurality of low-frequency subband signals having a predetermined bandwidth and supplies the plurality of low-frequency subband signals to the feature calculation circuit 272 and the decoding high-frequency signal generation circuit 275.

On the basis of the low-frequency subband signals supplied from the subband split circuit 271, the feature calculation circuit 272 calculates features, and supplies the features to the decoding high-frequency subband power calculation circuit 274.

The high-frequency decoding circuit 273 decodes the supplied high-frequency encoded data and supplies a high-frequency subband power estimation coefficient corresponding to indices obtained thereby to the decoding high-frequency subband power calculation circuit 274.

For each of a plurality of indices, at the high-frequency decoding circuit 273, a high-frequency subband power estimation coefficient is recorded in association with the index.

In this case, on the encoding side of an audio signal, an index representing a high-frequency subband power estimation coefficient most suited for a bandwidth expansion process at the bandwidth expanding section 82 is selected, and the selected index is encoded. Then, high-frequency encoded data obtained by encoding is stored in a bitstream and supplied to the signal processing apparatus 11.

Accordingly, the high-frequency decoding circuit 273 selects one represented by the index obtained by the decoding of the high-frequency encoded data from a plurality of high-frequency subband power estimation coefficients recorded in advance and supplies the coefficient to the decoding high-frequency subband power calculation circuit 274.

On the basis of the features supplied from the feature calculation circuit 272, and the high-frequency subband power estimation coefficient supplied from the high-frequency decoding circuit 273, the decoding high-frequency subband power calculation circuit 274 calculates high-frequency subband power and supplies the high-frequency subband power to the decoding high-frequency signal generation circuit 275.

On the basis of the low-frequency subband signals supplied from the subband split circuit 271, and the high-frequency subband power supplied from the decoding high-frequency subband power calculation circuit 274, the decoding high-frequency signal generation circuit 275 generates a high-frequency signal, and supplies the high-frequency signal to the synthesizing circuit 276.

The synthesizing circuit 276 synthesizes the audio signal supplied from the dynamic range expanding section 81, and the high-frequency signal supplied from the decoding high-frequency signal generation circuit 275, and supplies a high-sound-quality signal obtained thereby to the renderer 24 or the reproduction signal generating section 25.

The high-frequency signal obtained at the decoding high-frequency signal generation circuit 275 is a high-frequency-component signal not included in the original audio signal. Accordingly, by synthesizing such a high-frequency signal with the original audio signal, a high-sound-quality signal with higher sound quality including components in a wider frequency band can be obtained.

Because a high-frequency signal is predicted by using the high-frequency subband power estimation coefficient represented by the supplied index in the bandwidth expansion process by the bandwidth expanding section 82 like the one mentioned above, the prediction can be achieved with a still smaller processing load than in the case of the bandwidth expanding section 72 depicted in FIG. 6.

### <Explanation of Reproduction Signal Generation Process>

Next, operation of the signal processing apparatus 11 is explained.

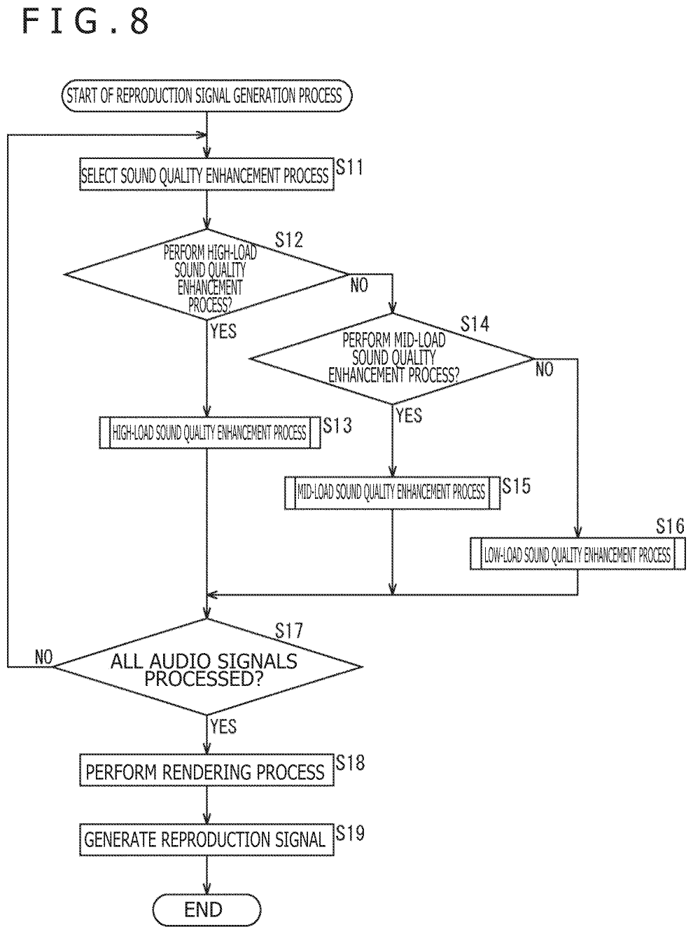

That is, a reproduction signal generation process by the signal processing apparatus 11 is explained below with reference to a flowchart in FIG. 8. This reproduction signal generation process is started when the decoding section 21 decodes supplied encoded data, and supplies an audio signal and metadata obtained by the decoding to a selecting section 31.

At Step S11, on the basis of the metadata supplied from the decoding section 21, the selecting section 31 selects a sound quality enhancement process to be performed on the audio signal supplied from the decoding section 21.

That is, for example, on the basis of priority information and type information included in the supplied metadata, the selecting section 31 selects, as the sound quality enhancement process, a process which is any of the high-load sound quality enhancement process, the mid-load sound quality enhancement process, and the low-load sound quality enhancement process.

Specifically, for example, at Step S11, the high-load sound quality enhancement process is selected in a case where a priority represented by the priority information is equal to or lower than a predetermined value or in a case where a type represented by the type information is a particular type such as center channel or vocal.

Note that, whereas at least either the priority information or the type information is used for the selection of the sound quality enhancement process, other than them, the sound quality enhancement process may be selected by using information representing the processing power of the signal processing apparatus 11 or the like.

Specifically, for example, in a case where the processing power represented by information representing the processing power is equal to or higher than a predetermined value, the value of the selection priority of the high-load sound quality enhancement process or the like is changed such that the number of audio signals for which the high-load sound quality enhancement process is selected increases.

At Step S12, the selecting section 31 determines whether to or not to perform the high-load sound quality enhancement process.

For example, in a case where the high-load sound quality enhancement process is selected as a result of the selection at Step S11, it is determined at Step S12 to perform the high-load sound quality enhancement process.

In a case where it is determined at Step S12 to perform the high-load sound quality enhancement process, the selecting section 31 supplies the audio signal supplied from the decoding section 21 to the high-load sound-quality-enhancement processing section 32, and thereafter the process proceeds to Step S13.

At Step S13, on the audio signal supplied from the selecting section 31, the high-load sound-quality-enhancement processing section 32 performs the high-load sound quality enhancement process, and outputs a high-sound-quality signal obtained thereby. Note that details of the high-load sound quality enhancement process are mentioned later.

For example, in a case where the audio signal with enhanced sound quality is a signal of an object, the high-load sound-quality-enhancement processing section 32 supplies the obtained high-sound-quality signal to the renderer 24. In this case, the selecting section 31 supplies, to the renderer 24 via the sound-quality-enhancement processing section 23, positional information included in the metadata supplied from the decoding section 21.

In contrast to this, in a case where the audio signal with enhanced sound quality is a signal of a channel, the high-load sound-quality-enhancement processing section 32 supplies the obtained high-sound-quality signal to the reproduction signal generating section 25.

After the high-load sound quality enhancement process is performed, and the high-sound-quality signal is generated, the process proceeds to Step S17.

In addition, in a case where it is determined at Step S12 not to perform the high-load sound quality enhancement process, at Step S14, the selecting section 31 determines whether to or not to perform the mid-load sound quality enhancement process.

For example, in a case where the mid-load sound quality enhancement process is selected as a result of the selection at Step S11, it is determined at Step S14 to perform the mid-load sound quality enhancement process.

In a case where it is determined at Step S14 to perform the mid-load sound quality enhancement process, the selecting section 31 supplies the audio signal supplied from the decoding section 21 to the mid-load sound-quality-enhancement processing section 33, and thereafter the process proceeds to Step S15.

At Step S15, on the audio signal supplied from the selecting section 31, the mid-load sound-quality-enhancement processing section 33 performs the mid-load sound quality enhancement process, and outputs a high-sound-quality signal obtained thereby. Note that details of the mid-load sound quality enhancement process are mentioned later.

For example, in a case where the audio signal with enhanced sound quality is a signal of an object, the mid-load sound-quality-enhancement processing section 33 supplies the obtained high-sound-quality signal to the renderer 24. In this case, the selecting section 31 supplies, to the renderer 24 via the sound-quality-enhancement processing section 23, positional information included in the metadata supplied from the decoding section 21.

In contrast to this, in a case where the audio signal with enhanced sound quality is a signal of a channel, the mid-load sound-quality-enhancement processing section 33 supplies the obtained high-sound-quality signal to the reproduction signal generating section 25.

After the mid-load sound quality enhancement process is performed, and the high-sound-quality signal is generated, the process proceeds to Step S17.

In addition, in a case where it is determined at Step S14 not to perform the mid-load sound quality enhancement process, that is, the low-load sound quality enhancement process is to be performed, the process proceeds to Step S16. In this case, the selecting section 31 supplies, to the low-load sound-quality-enhancement processing section 34, the audio signal supplied from the decoding section 21.

At Step S16, on the audio signal supplied from the selecting section 31, the low-load sound-quality-enhancement processing section 34 performs the low-load sound quality enhancement process and outputs a high-sound-quality signal obtained thereby. Note that details of the low-load sound quality enhancement process are mentioned later.

For example, in a case where the audio signal with enhanced sound quality is a signal of an object, the low-load sound-quality-enhancement processing section 34 supplies the obtained high-sound-quality signal to the renderer 24. In this case, the selecting section 31 supplies, to the renderer 24 via the sound-quality-enhancement processing section 23, positional information included in the metadata supplied from the decoding section 21.

In contrast to this, in a case where the audio signal with enhanced sound quality is a signal of a channel, the low-load sound-quality-enhancement processing section 34 supplies the obtained high-sound-quality signal to the reproduction signal generating section 25.

After the low-load sound quality enhancement process is performed, and the high-sound-quality signal is generated, the process proceeds to Step S17.

After the process at Step S13, Step S15 or Step S16 is performed, a process at Step S17 is performed.

At Step S17, the audio selecting section 22 determines whether or not all audio signals supplied from the decoding section 21 have been processed.

For example, at Step S17, it is determined that all the audio signals have been processed in a case where the selection of sound quality enhancement processes for the supplied audio signals has been performed at the selecting section 31-1 to the selecting section 31-m, and the sound quality enhancement processes have been performed at the sound-quality-enhancement processing section 23 according to a result of the selection. In this case, high-sound-quality signals corresponding to all the audio signals have been generated.

In a case where it is determined at Step S17 that not all the audio signals have been processed yet, the process returns to Step S11, and the processes mentioned above are performed repeatedly.

For example, in a case where the process at Step S11 has not been performed yet at the selecting section 31-n, the processes at Step S11 to Step S16 mentioned above are performed on an audio signal supplied to the selecting section 31-n. Note that, more specifically, at the audio selecting section 22, the selecting sections 31 perform the processes at Step S11 to Step S16 in parallel.

In contrast to this, in a case where it is determined at Step S17 that all the audio signals have been processed, thereafter the process proceeds to Step S18.

At Step S18, the renderer 24 performs a rendering process on the n high-sound-quality signals in total supplied from the high-load sound-quality-enhancement processing sections 32, mid-load sound-quality-enhancement processing sections 33 and low-load sound-quality-enhancement processing sections 34 in the sound-quality-enhancement processing section 23.

For example, by performing VBAP on the basis of positional information and high-sound-quality signals of objects supplied from the sound-quality-enhancement processing section 23, the renderer 24 generates object reproduction signals, and supplies the object reproduction signals to the reproduction signal generating section 25.

At Step S19, the reproduction signal generating section 25 synthesizes the object reproduction signals supplied from the renderer 24, and high-sound-quality signals of channels supplied from the high-load sound-quality-enhancement processing sections 32, the mid-load sound-quality-enhancement processing sections 33, and the low-load sound-quality-enhancement processing sections 34, and generates reproduction signals.

The reproduction signal generating section 25 outputs the obtained reproduction signals to the downstream side, and thereafter the reproduction signal generation process ends.

In the manner mentioned above, on the basis of priority information and type information included in metadata, the signal processing apparatus 11 selects a sound quality enhancement process to be performed on each audio signal from a plurality of sound quality enhancement processes requiring mutually different processing loads, and performs the sound quality enhancement process according to a result of the selection. By doing so, it is possible to reduce the processing load as a whole, and obtain reproduction signals with sufficiently high sound quality even with a small processing load, that is, a small processing amount.

### <Explanation of High-Load Sound Quality Enhancement Process>

Here, the high-load sound quality enhancement process at Step S13, the mid-load sound quality enhancement process at Step S15 and the low-load sound quality enhancement process at Step S16 that are explained with reference to FIG. 8 are explained in more detail.

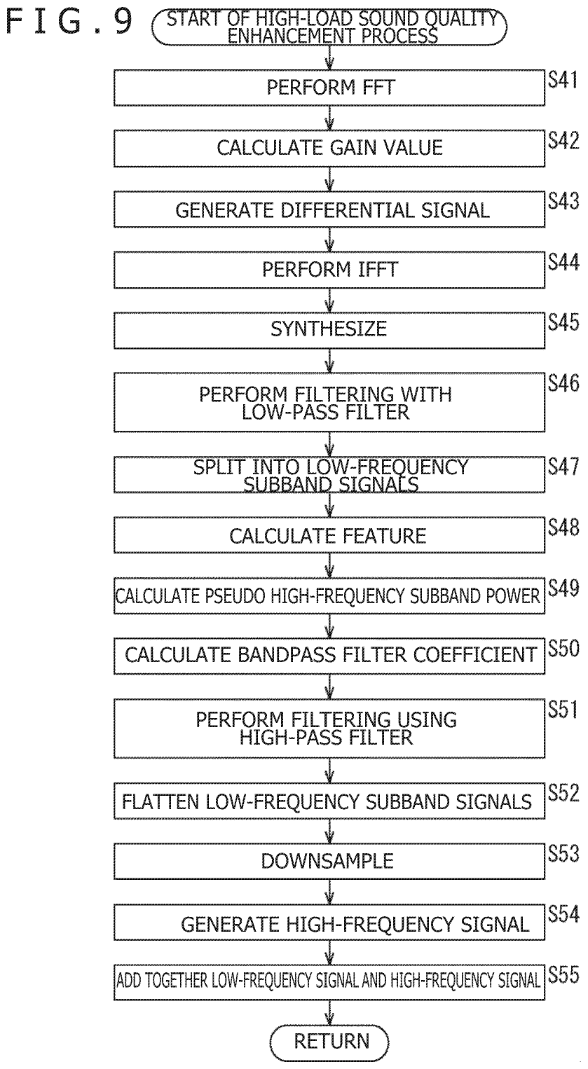

First, with reference to a flowchart in FIG. 9, the high-load sound quality enhancement process corresponding to the process at Step S13 in FIG. 8 performed by a high-load sound-quality-enhancement processing sections 32 is explained.

At Step S41, the FFT processing section 111 performs a FFT on an audio signal supplied from the selecting section 31, and supplies a signal obtained thereby to the gain calculating section 112 and the differential signal generating section 113.

At Step S42, on the basis of the retained prediction coefficients, and the signal supplied from the FFT processing section 111, the gain calculating section 112 calculates a gain value for generating a differential signal, and supplies the gain value to the differential signal generating section 113. At Step S42, on the basis of the prediction coefficients and the signal supplied from the FFT processing section 111, computations in a DNN are performed, and a gain value of the frequency envelope of a differential signal is calculated.

At Step S43, on the basis of the signal supplied from the FFT processing section 111, and the gain value supplied from the gain calculating section 112, the differential signal generating section 113 generates a differential signal, and supplies the differential signal to the IFFT processing section 114. For example, at Step S43, by performing gain adjustment on the signal supplied from the FFT processing section 111 on the basis of the gain value, the differential signal is generated.

At Step S44, on the differential signal supplied from the differential signal generating section 113, the IFFT processing section 114 performs an IFFT, and supplies a differential signal obtained thereby to the synthesizing section 115.

At Step S45, the synthesizing section 115 synthesizes the audio signal supplied from the selecting section 31, and the differential signal supplied from the IFFT processing section 114, and supplies an audio signal obtained thereby to the polyphase configuration low-pass filter 141, feature calculation circuit 144, and bandpass filters 161 of the bandwidth expanding section 62.

At Step S46, on the audio signal supplied from the synthesizing section 115, the polyphase configuration low-pass filter 141 performs filtering with a low-pass filter with polyphase configuration, and supplies a low-frequency signal obtained thereby to the delay circuit 142.

In addition, the delay circuit 142 delays the low-frequency signal supplied from the polyphase configuration low-pass filter 141 by a certain length of delay time, and thereafter supplies the low-frequency signal to the adding section 152.

At Step S47, by allowing passage therethrough of signals in subbands on the low-frequency side in the audio signal supplied from the synthesizing section 115, the bandpass filters 161 split the audio signal into a plurality of low-frequency subband signals, and supply the plurality of low-frequency subband signals to the feature calculation circuit 144 and the flattening circuit 149.

At Step S48, on the basis of at least either the plurality of low-frequency subband signals supplied from the bandpass filters 161 or the audio signal supplied from the synthesizing section 115, the feature calculation circuit 144 calculates features, and supplies the features to the high-frequency subband power estimation circuit 145.

At Step S49, on the basis of the prediction coefficients retained in advance, and the features supplied from the feature calculation circuit 144, the high-frequency subband power estimation circuit 145 calculates pseudo high-frequency subband power for each of high-frequency subbands, and supplies the pseudo high-frequency subband power to the bandpass filter calculation circuit 146.

At Step S50, on the basis of the pseudo high-frequency subband power of a plurality of the high-frequency subbands supplied from the high-frequency subband power estimation circuit 145, the bandpass filter calculation circuit 146 calculates bandpass filter coefficients and supplies the bandpass filter coefficients to the adding section 147.

In addition, the adding section 147 adds together the bandpass filter coefficients supplied from the bandpass filter calculation circuit 146 into one filter coefficient and supplies the filter coefficient to the high-pass filter 148.

At Step S51, the high-pass filter 148 performs filtering on the filter coefficient supplied from the adding section 147 using a high-pass filter and supplies a filter coefficient obtained thereby to the polyphase configuration level adjustment filter 151.

At Step S52, by flattening and adding together the low-frequency subband signals in a plurality of low-frequency subbands supplied from the bandpass filters 161, the flattening circuit 149 generates a flattened signal, and supplies the flattened signal to the downsampling section 150.

At Step S53, the downsampling section 150 performs downsampling on the flattened signal supplied from the flattening circuit 149 and supplies the downsampled flattened signal to the polyphase configuration level adjustment filter 151.

At Step S54, by performing filtering using the filter coefficient supplied from the high-pass filter 148 on the flattened signal supplied from the downsampling section 150, the polyphase configuration level adjustment filter 151 generates a high-frequency signal and supplies the high-frequency signal to the adding section 152.

At Step S55, by adding together the low-frequency signal supplied from the delay circuit 142, and the high-frequency signal supplied from the polyphase configuration level adjustment filter 151, the adding section 152 generates a high-sound-quality signal and outputs the high-sound-quality signal. After the high-sound-quality signal is generated in such a manner, the high-load sound quality enhancement process ends, and thereafter the process proceeds to Step S17 in FIG. 8.

In the manner mentioned above, the high-load sound-quality-enhancement processing section 32 combines a dynamic range expansion process and a bandwidth expansion process that require a high load, but make it possible to obtain high-sound-quality signals, and generates high-sound-quality signals with higher sound quality. By doing so, high-sound-quality signals can be obtained for important audio signals such as ones with high priorities.

### <Explanation of Mid-Load Sound Quality Enhancement Process>

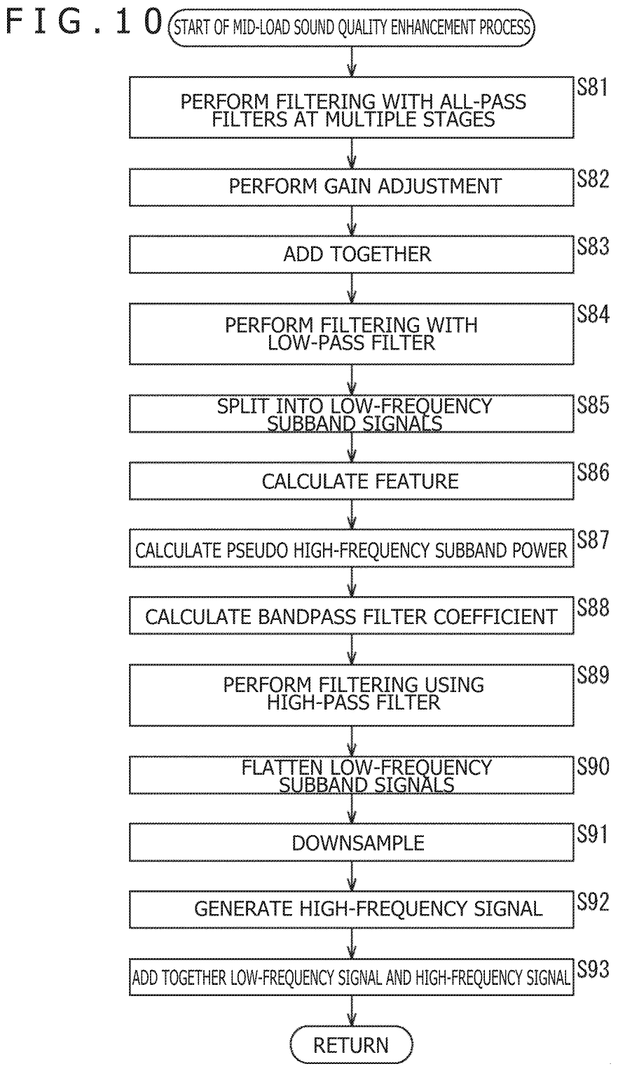

Next, with reference to a flowchart in FIG. 10, the mid-load sound quality enhancement process corresponding to Step S15 in FIG. 8 performed by a mid-load sound-quality-enhancement processing sections 33 is explained.

At Step S81, on an audio signal supplied from the selecting section 31, the all-pass filters 191 perform filtering with all-pass filters at multiple stages, and supply an audio signal obtained thereby to the gain adjusting section 192.

That is, at Step S81, filtering is performed at the all-pass filter 191-1 to the all-pass filter 191-3.

At Step S82, on the audio signal supplied from the all-pass filter 191-3, the gain adjusting section 192 performs gain adjustment and supplies the audio signal after the gain adjustment to the adding section 193.

At Step S83, the adding section 193 adds together the audio signal supplied from the gain adjusting section 192 and the audio signal supplied from the selecting section 31, and supplies an audio signal obtained thereby to the polyphase configuration low-pass filter 221, feature calculation circuit 224, and bandpass filters 241 of the bandwidth expanding section 72.

After the process at Step S83 is performed, processes at Step S84 to Step S86 are performed by the polyphase configuration low-pass filter 221, the bandpass filters 241, and the feature calculation circuit 224. Note that, because these processes are similar to the processes at Step S46 to Step S48 in FIG. 9, explanations thereof are omitted.

At Step S87, on the basis of the retained coefficients, and the features supplied from the feature calculation circuit 224, the high-frequency subband power estimation circuit 225 calculates pseudo high-frequency subband power by linear prediction, and supplies the pseudo high-frequency subband power to the bandpass filter calculation circuit 226.

After the process at Step S87 is performed, the bandpass filter calculation circuit 226 to the adding section 232 perform processes at Step S88 to Step S93, and the mid-load sound quality enhancement process ends. Note that, because these processes are similar to the processes at Step S50 to Step S55 in FIG. 9, explanations thereof are omitted. After the mid-load sound quality enhancement process ends, the process proceeds to Step S17 in FIG. 8.

In the manner mentioned above, the mid-load sound-quality-enhancement processing section 33 combines a dynamic range expansion process and a bandwidth expansion process that make it possible to obtain signals with sound quality which is high to some extent with an intermediate load, and enhances the sound quality of audio signals of objects and channels. By doing so, signals with sound quality which is high to some extent can be obtained with an intermediate load for audio signals with priorities which are high to some extent, and so on.

### <Explanation of Low-Load Sound Quality Enhancement Process>

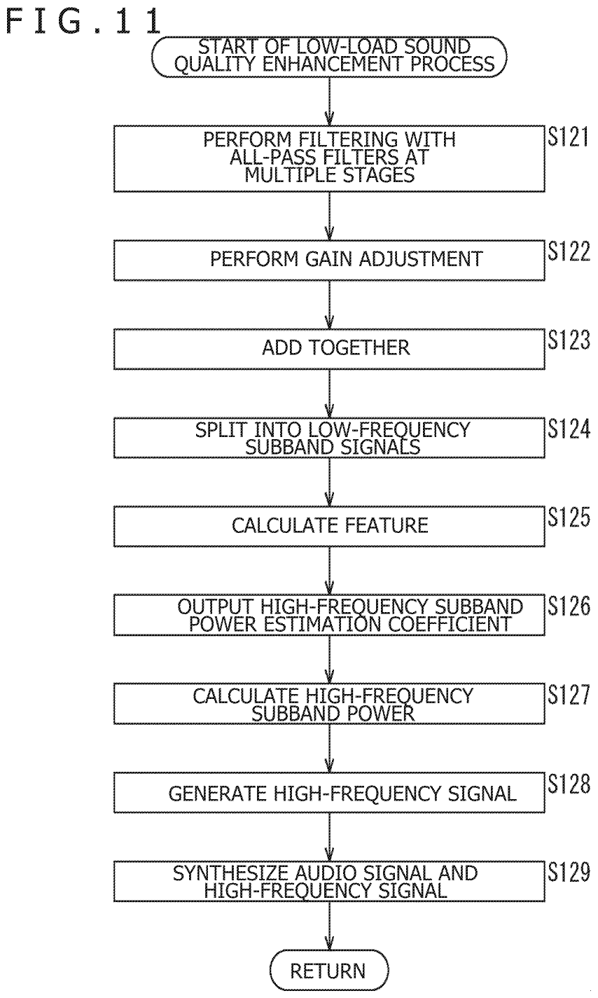

Furthermore, with reference to a flowchart in FIG. 11, the low-load sound quality enhancement process corresponding to Step S16 in FIG. 8 performed by a low-load sound-quality-enhancement processing sections 34 is explained.

Note that, because processes at Step S121 to Step S123 are similar to the processes at Step S81 to Step S83 in FIG. 10, explanations thereof are omitted.

After the process at Step S123 is performed, an audio signal obtained by the process at Step S123 is supplied from the dynamic range expanding section 81 to the subband split circuit 271 and synthesizing circuit 276 of the bandwidth expanding section 82, and a process at Step S124 is performed.

At Step S124, the subband split circuit 271 splits the audio signal supplied from the dynamic range expanding section 81 into a plurality of low-frequency subband signals and supplies the plurality of low-frequency subband signals to the feature calculation circuit 272 and the decoding high-frequency signal generation circuit 275.

At Step S125, on the basis of the low-frequency subband signals supplied from the subband split circuit 271, the feature calculation circuit 272 calculates features, and supplies the features to the decoding high-frequency subband power calculation circuit 274.

At Step S126, the high-frequency decoding circuit 273 decodes the supplied high-frequency encoded data, and outputs (supplies) a high-frequency subband power estimation coefficient corresponding to indices obtained thereby to the decoding high-frequency subband power calculation circuit 274.

At Step S127, on the basis of the features supplied from the feature calculation circuit 272, and the high-frequency subband power estimation coefficient supplied from the high-frequency decoding circuit 273, the decoding high-frequency subband power calculation circuit 274 calculates high-frequency subband power and supplies the high-frequency subband power to the decoding high-frequency signal generation circuit 275. For example, at Step S127, the high-frequency subband power is calculated by determining the sum of the features multiplied by the high-frequency subband power estimation coefficient.

At Step S128, on the basis of the low-frequency subband signals supplied from the subband split circuit 271, and the high-frequency subband power supplied from the decoding high-frequency subband power calculation circuit 274, the decoding high-frequency signal generation circuit 275 generates a high-frequency signal, and supplies the high-frequency signal to the synthesizing circuit 276. For example, at Step S128, on the basis of the low-frequency subband signals and the high-frequency subband power, frequency modulation and gain adjustment on the low-frequency subband signals are performed, and the high-frequency signal is generated.

At Step S129, the synthesizing circuit 276 synthesizes the audio signal supplied from the dynamic range expanding section 81, and the high-frequency signal supplied from the decoding high-frequency signal generation circuit 275 and outputs a high-sound-quality signal obtained thereby. After the high-sound-quality signal is generated in such a manner, the low-load sound quality enhancement process ends, and thereafter the process proceeds to Step S17 in FIG. 8.

In the manner mentioned above, the low-load sound-quality-enhancement processing section 34 combines a dynamic range expansion process and a bandwidth expansion process that can achieve sound quality enhancement with a low load, and enhances the sound quality of audio signals of objects and channels. By doing so, sound quality enhancement is performed with a low load for audio signals which are not so important such as ones with low priorities, and the overall processing load can be reduced.

### Second Embodiment

### <Configuration Example of Signal Processing Apparatus>

As mentioned above, at a high-load sound-quality-enhancement processing section 32, prediction coefficients used for computations in a DNN obtained in advance by machine learning are used to estimate (predict) a gain of a frequency envelope and pseudo high-frequency subband power.

At this time, if the types of audio signals can be identified, it is also possible to learn a prediction coefficient for each type. By doing so, it is possible to predict a gain of a frequency envelope and pseudo high-frequency subband power more precisely and additionally with a smaller processing load by using a prediction coefficient according to the type of an audio signal.

In particular, if a prediction coefficient for each type of audio signal, that is, a DNN, is machine-learned, it is possible to predict a gain value and pseudo high-frequency subband power more precisely with a smaller-scale DNN, and to reduce the processing load.

On the other hand, if there are no problems in terms of processing load, the same DNN, that is, the same prediction coefficients, may be used independently of the types of audio signals. In such a case, for example, it is sufficient if typical stereo audio contents of various sound sources which are also called a complete package or the like are used for machine learning of prediction coefficients.

Prediction coefficients that are generated by machine learning using audio contents including sounds of various sound sources such as a complete package, and used commonly for all types are particularly referred to also as general prediction coefficients below.

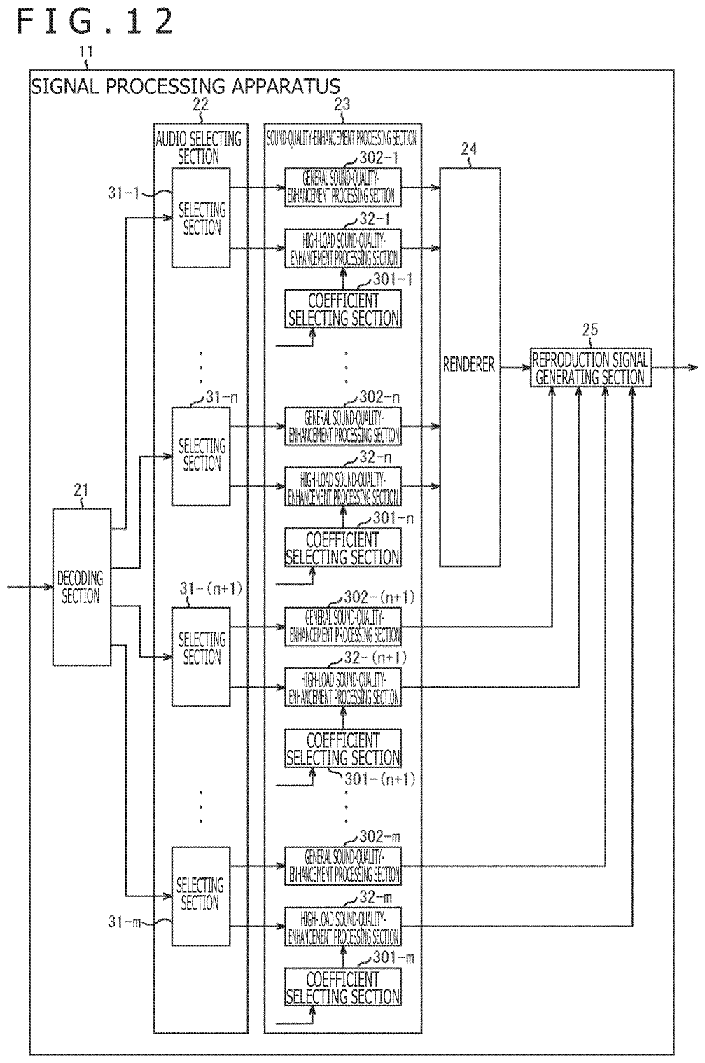

In the first embodiment mentioned above, the types of audio signals can be identified because metadata of each audio signal includes type information representing the type of the audio signal. In view of this, for example, as depicted in FIG. 12, sound quality enhancement may be performed by selecting a prediction coefficient according to type information. Note that portions in FIG. 12 that have counterparts in the case in FIG. 1 are given identical reference characters, and explanations thereof are omitted as appropriate.

The signal processing apparatus 11 depicted in FIG. 12 has the decoding section 21, the audio selecting section 22, the sound-quality-enhancement processing section 23, the renderer 24, and the reproduction signal generating section 25.

In addition, the audio selecting section 22 has the selecting section 31-1 to the selecting section 31-m.

Furthermore, the sound-quality-enhancement processing section 23 has a general sound-quality-enhancement processing section 302-1 to a general sound-quality-enhancement processing section 302-m, the high-load sound-quality-enhancement processing section 32-1 to the high-load sound-quality-enhancement processing section 32-m, and a coefficient selecting section 301-1 to a coefficient selecting section 301-m.

Accordingly, the signal processing apparatus 11 depicted in FIG. 12 is different from the signal processing apparatus 11 depicted in FIG. 1 only in terms of the configuration of the sound-quality-enhancement processing section 23, and the configuration is the same in other respects.

The coefficient selecting section 301-1 to the coefficient selecting section 301-m retain in advance prediction coefficients that are machine-learned for each type of audio signal, and used for computations in a DNN, and these coefficient selecting section 301-1 to coefficient selecting section 301-m are supplied with metadata from the decoding section 21.

The prediction coefficients mentioned here are prediction coefficients used for processes at a high-load sound-quality-enhancement processing section 32, more specifically the gain calculating section 112 of the dynamic range expanding section 61, and the high-frequency subband power estimation circuit 145 of the bandwidth expanding section 62.

From the prediction coefficients each corresponding to one of a plurality of types retained in advance, the coefficient selecting section 301-1 to the coefficient selecting section 301-m select a prediction coefficient of a type represented by type information included in metadata supplied from the decoding section 21, and supply the prediction coefficient to the high-load sound-quality-enhancement processing section 32-1 to the high-load sound-quality-enhancement processing section 32-m. That is, for each audio signal, a prediction coefficient to be used for a high-load sound quality enhancement process to be performed on the audio signal is selected.

Note that, in a case where it is not particularly necessary to make distinctions among the coefficient selecting section 301-1 to the coefficient selecting section 301-m below, they are also referred to as coefficient selecting sections 301 simply.

The general sound-quality-enhancement processing section 302-1 to the general sound-quality-enhancement processing section 302-m are basically configured similarly to the high-load sound-quality-enhancement processing sections 32.

It should be noted that, at the general sound-quality-enhancement processing section 302-1 to the general sound-quality-enhancement processing section 302-m, a configuration of blocks corresponding to the gain calculating section 112 and the high-frequency subband power estimation circuit 145, that is, the DNN configuration, is different from the high-load sound-quality-enhancement processing sections 32, and those blocks retain general prediction coefficients mentioned above.

Other than this, in the general sound-quality-enhancement processing section 302-1 to the general sound-quality-enhancement processing section 302-m, for example, the DNN configuration or the like may be made different according to whether an audio signal to be input is a signal of an object or of a channel, and so on.

After being supplied with audio signals from the selecting section 31-1 to the selecting section 31-m, on the basis of the audio signals, and general prediction coefficients retained in advance, the general sound-quality-enhancement processing section 302-1 to the general sound-quality-enhancement processing section 302-m perform sound quality enhancement processes, and supply high-sound-quality signals obtained thereby to the renderer 24 or the reproduction signal generating section 25.

Note that, in a case where it is not particularly necessary to make distinctions among the general sound-quality-enhancement processing section 302-1 to the general sound-quality-enhancement processing section 302-m below, they are also referred to as general sound-quality-enhancement processing sections 302 simply. In addition, a sound quality enhancement process performed at the general sound-quality-enhancement processing sections 302 is particularly referred to also as a general sound quality enhancement process below.

In such a manner, in the example depicted in FIG. 12, on the basis of priority information and type information included in metadata, each selecting section 31 selects either a general sound-quality-enhancement processing section 302 or a high-load sound-quality-enhancement processing section 32 as the destination of supply of an audio signal.

### <Explanation of Reproduction Signal Generation Process>

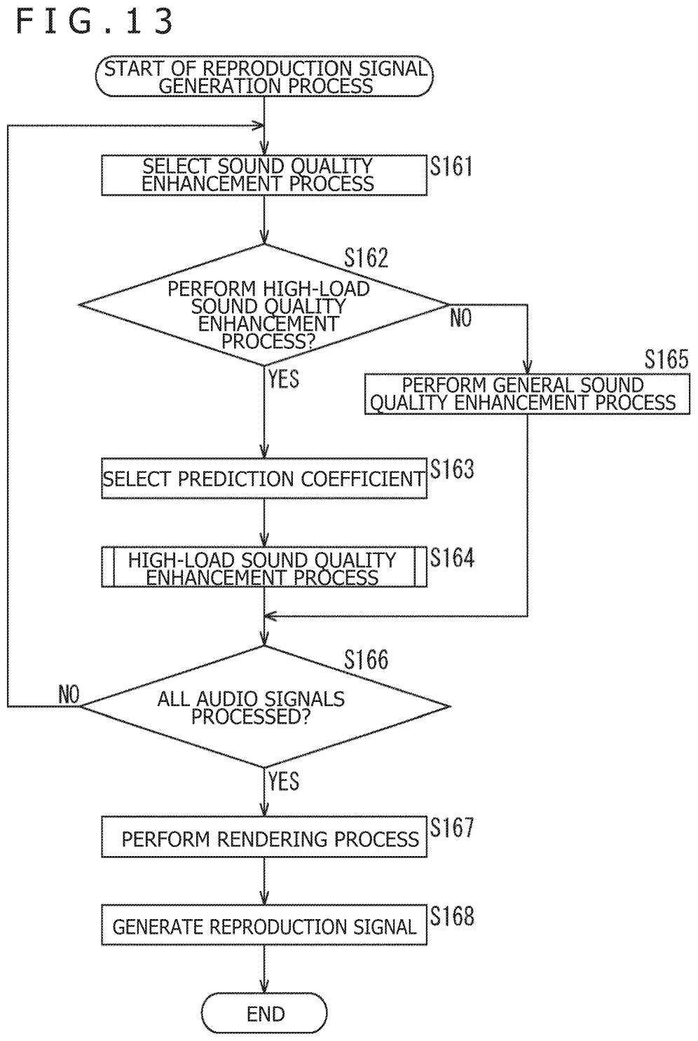

Next, a reproduction signal generation process performed by the signal processing apparatus 11 depicted in FIG. 12 is explained below with reference to a flowchart in FIG. 13.

At Step S161, on the basis of metadata supplied from the decoding section 21, a selecting section 31 selects a sound quality enhancement process to be performed on an audio signal supplied from the decoding section 21.

For example, in a case where a type represented by type information included in the metadata is a type for which a prediction coefficient is retained in advance at the coefficient selecting section 301, the selecting section 31 selects the high-load sound quality enhancement process. In contrast to this, for example, in a case where a type represented by type information is a type for which a prediction coefficient is not retained in the coefficient selecting section 301, the general sound quality enhancement process is selected.

At Step S162, the selecting section 31 determines whether or not the high-load sound quality enhancement process has been selected at Step S161, that is, whether to or not to perform the high-load sound quality enhancement process.

In a case where it is determined at Step S162 to perform the high-load sound quality enhancement process, the selecting section 31 supplies, to the high-load sound-quality-enhancement processing section 32, the audio signal supplied from the decoding section 21, and thereafter the process proceeds to Step S163.

At Step S163, from the prediction coefficients each corresponding to one of a plurality of types retained in advance, the coefficient selecting section 301 selects the prediction coefficient of the type represented by the type information included in the metadata supplied from the decoding section 21, and supplies the prediction coefficient to the high-load sound-quality-enhancement processing section 32.

Here, a prediction coefficient that has been generated in advance for a type by machine learning, and is to be used in each of the gain calculating section 112 and the high-frequency subband power estimation circuit 145 is selected, and the prediction coefficient is supplied to the gain calculating section 112 and the high-frequency subband power estimation circuit 145.

After the prediction coefficient is selected, a process at Step S164 is performed. That is, at Step S164, the high-load sound quality enhancement process explained with reference to FIG. 9 is performed.

It should be noted that, at Step S42, on the basis of a prediction coefficient supplied from the coefficient selecting section 301, and a signal supplied from the FFT processing section 111, the gain calculating section 112 calculates a gain value for generating a differential signal. In addition, at Step S49, on the basis of the prediction coefficient supplied from the coefficient selecting section 301, and features supplied from the feature calculation circuit 144, the high-frequency subband power estimation circuit 145 calculates pseudo high-frequency subband power.

In addition, in a case where it is determined at Step S162 not to perform the high-load sound quality enhancement process, that is, in a case where it is determined to perform the general sound quality enhancement process, the selecting section 31 supplies, to the general sound-quality-enhancement processing section 302, the audio signal supplied from the decoding section 21, and thereafter the process proceeds to Step S165.

At Step S165, the general sound-quality-enhancement processing section 302 performs the general sound quality enhancement process on the audio signal supplied from the selecting section 31, and supplies a high-sound-quality signal obtained thereby to the renderer 24 or the reproduction signal generating section 25.

In the general sound quality enhancement process, basically, a process similar to the high-load sound quality enhancement process explained with reference to FIG. 9 is performed to generate a high-sound-quality signal.

It should be noted that, for example, in a process that is in the general sound quality enhancement process, and corresponds to Step S42 in FIG. 9, the general prediction coefficients retained in advance are used to calculate a gain value for generating a differential signal. In addition, in a process corresponding to Step S49 in FIG. 9, the general prediction coefficients retained in advance are used to calculate pseudo high-frequency subband power.

After the process at Step S164 or Step S165 is performed in the manner mentioned above, processes at Step S166 to Step S168 are performed, and the reproduction signal generation process ends. Because these processes are similar to the processes at Step S17 to Step S19 in FIG. 8, explanations thereof are omitted.

In the manner mentioned above, on the basis of priority information and type information included in metadata, the signal processing apparatus 11 performs the general sound quality enhancement process or the high-load sound quality enhancement process selectively, and generates reproduction signals. By doing so, it is possible to obtain reproduction signals with sufficiently high sound quality even with a small processing load, that is, a small processing amount. Particularly, in this example, by preparing a prediction coefficient for each type of audio signal, high-sound-quality reproduction signals can be obtained with a small processing load.

### First Modification Example of Second Embodiment

### <Configuration Example of Signal Processing Apparatus>

Note that the high-load sound quality enhancement process or the general sound quality enhancement process is selected as a sound quality enhancement process in the example explained with reference to FIG. 12. However, this is not the sole example, and any two or more of the high-load sound quality enhancement process, the mid-load sound quality enhancement process, the low-load sound quality enhancement process, and the general sound quality enhancement process may be selected.

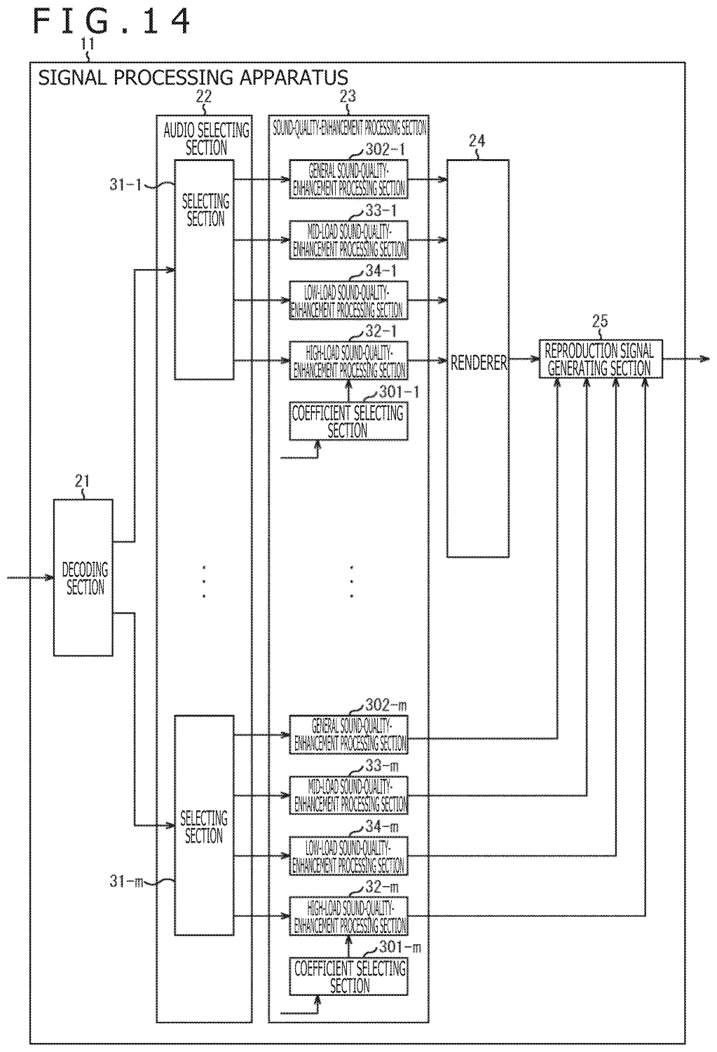

For example, in a case where any of the high-load sound quality enhancement process, the mid-load sound quality enhancement process, the low-load sound quality enhancement process, and the general sound quality enhancement process is selected as a sound quality enhancement process, the signal processing apparatus 11 is configured as depicted in FIG. 14. Note that portions in FIG. 14 that have counterparts in the case in FIG. 1 or FIG. 12 are given identical reference signs, and explanations thereof are omitted as appropriate.

The signal processing apparatus 11 depicted in FIG. 14 has the decoding section 21, the audio selecting section 22, the sound-quality-enhancement processing section 23, the renderer 24, and the reproduction signal generating section 25.

In addition, the audio selecting section 22 has the selecting section 31-1 to the selecting section 31-m.

Furthermore, the sound-quality-enhancement processing section 23 has the general sound-quality-enhancement processing section 302-1 to the general sound-quality-enhancement processing section 302-m, the mid-load sound-quality-enhancement processing section 33-1 to the mid-load sound-quality-enhancement processing section 33-m, the low-load sound-quality-enhancement processing section 34-1 to the low-load sound-quality-enhancement processing section 34-m, the high-load sound-quality-enhancement processing section 32-1 to the high-load sound-quality-enhancement processing section 32-m, and the coefficient selecting section 301-1 to the coefficient selecting section 301-m.

Accordingly, the signal processing apparatus 11 depicted in FIG. 14 is different from the signal processing apparatus 11 depicted in FIG. 1 or FIG. 12 only in terms of the configuration of the sound-quality-enhancement processing section 23, and the configuration is the same in other respects.

In this example, on the basis of metadata supplied from the decoding section 21, a selecting section 31 selects a sound quality enhancement process to be performed on an audio signal supplied from the decoding section 21.

That is, the selecting section 31 selects the high-load sound quality enhancement process, the mid-load sound quality enhancement process, the low-load sound quality enhancement process, or the general sound quality enhancement process, and, according to a result of the selection, supplies the audio signal to the high-load sound-quality-enhancement processing section 32, the mid-load sound-quality-enhancement processing section 33, the low-load sound-quality-enhancement processing section 34, or the general sound-quality-enhancement processing section 302.

### Third Embodiment

### <Configuration Example of Signal Processing Apparatus>

Furthermore, when the type of an audio signal cannot be identifies for a reason that metadata does not include type information or for other reasons in a case where the coefficient selecting sections 301 are provided in the sound-quality-enhancement processing section 23, prediction coefficients cannot be selected at the coefficient selecting sections 301, and it becomes not possible to perform the high-load sound quality enhancement process.

In view of this, for example, metadata generating sections that generate metadata on the basis of audio signals may be provided. Particularly, on the basis of audio signals, the types of the audio signals are identified, and type information representing a result of the identification is generated as metadata in an example explained below.

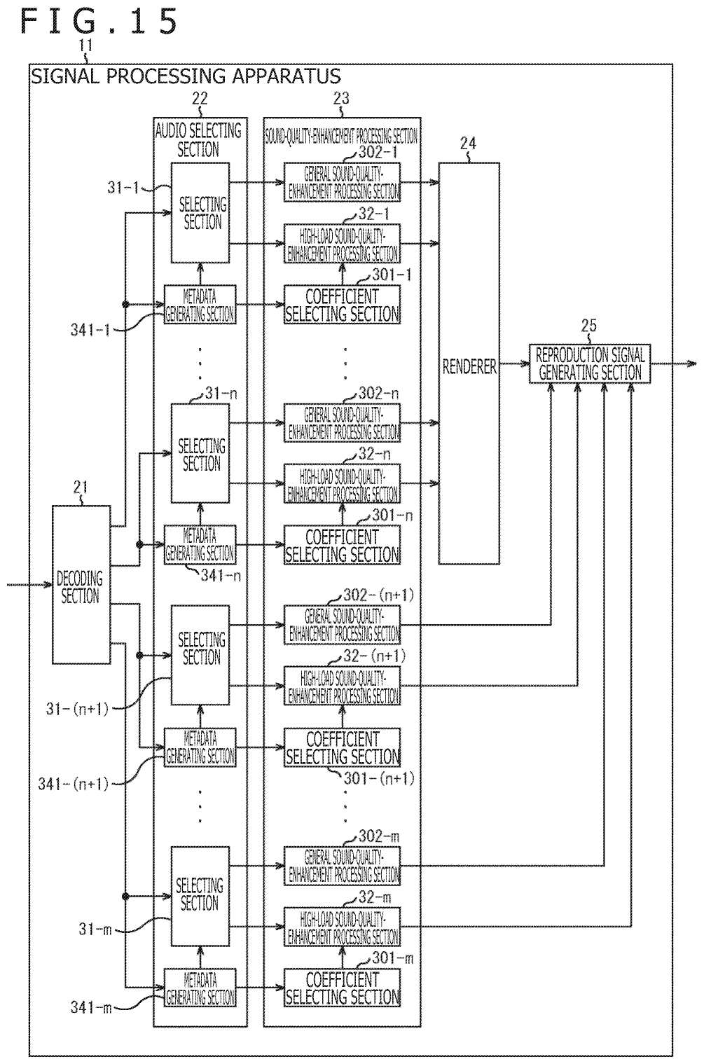

In such a case, the signal processing apparatus 11 is configured as depicted in FIG. 15, for example. Note that portions in FIG. 15 that have counterparts in the case in FIG. 12 are given identical reference signs, and explanations thereof are omitted as appropriate.

The signal processing apparatus 11 depicted in FIG. 15 has the decoding section 21, the audio selecting section 22, the sound-quality-enhancement processing section 23, the renderer 24, and the reproduction signal generating section 25.

In addition, the audio selecting section 22 has the selecting section 31-1 to the selecting section 31-m, and a metadata generating section 341-1 to a metadata generating section 341-m.

Furthermore, the sound-quality-enhancement processing section 23 has the general sound-quality-enhancement processing section 302-1 to the general sound-quality-enhancement processing section 302-m, the high-load sound-quality-enhancement processing section 32-1 to the high-load sound-quality-enhancement processing section 32-m, and the coefficient selecting section 301-1 to the coefficient selecting section 301-m.

Accordingly, the signal processing apparatus 11 depicted in FIG. 15 is different from the signal processing apparatus 11 depicted in FIG. 12 only in terms of the configuration of the audio selecting section 22, and the configuration is the same in other respects.

For example, the metadata generating section 341-1 to the metadata generating section 341-m are type classifiers such as DNNs generated in advance by machine learning or the like, and retain in advance type prediction coefficients for achieving the type classifiers. That is, by causing them to lean type prediction coefficients by machine learning or the like, type classifiers such as DNNs can be obtained.

On the basis of the type prediction coefficients retained in advance, and audio signals supplied from the decoding section 21, the metadata generating section 341-1 to the metadata generating section 341-m perform computations by the type classifiers to thereby identify (estimate) the types of the audio signals. For example, at the type classifiers, identification of types is performed on the basis of the frequency characteristics or the like of the audio signals.

The metadata generating section 341-1 to the metadata generating section 341-m generate type information, that is, metadata, representing results of the identification of the types, and supplies the type information to the selecting section 31-1 to the selecting section 31-m, and the coefficient selecting section 301-1 to the coefficient selecting section 301-m.

Note that, in a case where it is not particularly necessary to make distinctions among the metadata generating section 341-1 to the metadata generating section 341-m below, they are also referred to as metadata generating sections 341 simply.

In addition, type classifiers included in the metadata generating sections 341 may be ones that output information representing, about an input audio signal, which of a plurality of types the type of the audio signal is, or a plurality of type classifiers each of which corresponds to one particular type, and outputs information representing whether or not an input audio signal is of the one particular type may be prepared. For example, in a case where a type classifier is prepared for each type, audio signals are input to the type classifiers, and type information is generated on the basis of output of each of the type classifiers.

In addition, whereas the general sound-quality-enhancement processing section 302 and the high-load sound-quality-enhancement processing section 32 are provided in a sound-quality-enhancement processing section 23 in the example explained here, the mid-load sound-quality-enhancement processing section 33 and the low-load sound-quality-enhancement processing section 34 may be provided also.

### <Explanation of Reproduction Signal Generation Process>

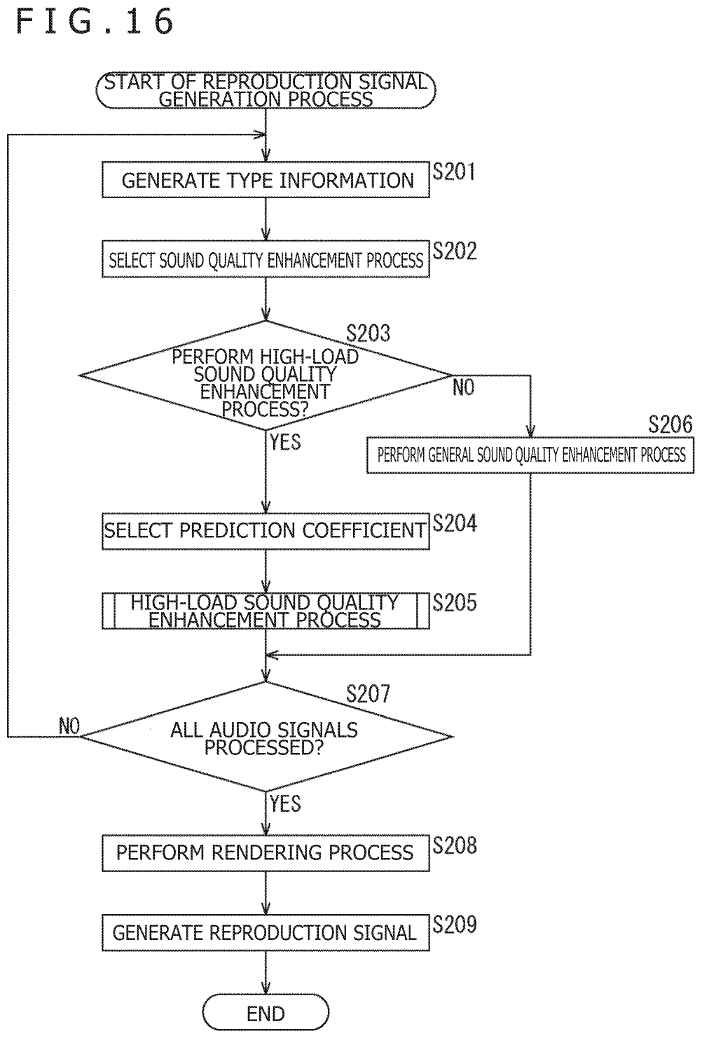

Next, a reproduction signal generation process performed by the signal processing apparatus 11 depicted in FIG. 15 is explained below with reference to a flowchart in FIG. 16.

At Step S201, on the basis of type prediction coefficients retained in advance, and an audio signal supplied from the decoding section 21, a metadata generating section 341 identifies the type of the audio signal, and generates type information representing a result of the identification. The metadata generating section 341 supplies the generated type information to the selecting section 31 and the coefficient selecting section 301.

Note that, more specifically, at the metadata generating section 341, the process at Step S201 is performed only in a case where metadata obtained at the decoding section 21 does not include type information. Here, the explanation is continued supposing that the metadata does not include type information.

At Step S202, on the basis of priority information included in the metadata supplied from the decoding section 21, and the type information supplied from the metadata generating section 341, the selecting section 31 selects a sound quality enhancement process to be performed on the audio signal supplied from the decoding section 21. Here, the high-load sound quality enhancement process or the general sound quality enhancement process is selected as a sound quality enhancement process.

After the sound quality enhancement process is selected, processes at Step S203 to Step S209 are performed, and the reproduction signal generation process ends. Because these processes are similar to the processes at Step S162 to Step S168 in FIG. 13, explanations thereof are omitted. It should be noted that, at Step S204, on the basis of the type information supplied from the metadata generating section 341, the coefficient selecting section 301 selects a prediction coefficient.

In the manner mentioned above, the signal processing apparatus 11 generates type information on the basis of audio signals, and selects sound quality enhancement processes on the basis of the type information and priority information. By doing so, even in a case where metadata does not include type information, type information can be generated, and a sound quality enhancement process and a prediction coefficient can be selected. Thereby, high-sound-quality reproduction signals can be obtained even with a small processing load.

### <Configuration Example of Computer>

Incidentally, the series of processing mentioned above can also be executed by hardware, or can also be executed by software. In a case where the series of processing is executed by software, a program included in the software is installed on computers. Here, the computers include computers incorporated in dedicated hardware, general-purpose personal computers, for example, that can execute various types of functionalities by having various types of programs installed thereon, and the like.

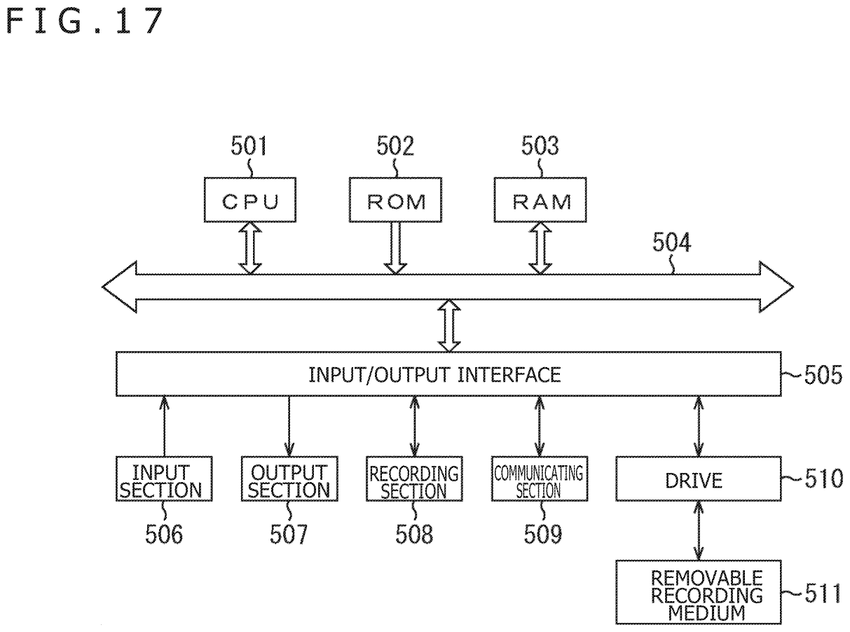

FIG. 17 is a block diagram depicting a configuration example of the hardware of a computer that executes the series of processing mentioned above by a program.

In the computer, a CPU (Central Processing Unit) 501, a ROM (Read Only Memory) 502, and a RAM (Random Access Memory) 503 are interconnected via a bus 504.

The bus 504 is further connected with an input/output interface 505. The input/output interface 505 is connected with an input section 506, an output section 507, a recording section 508, a communicating section 509, and a drive 510.

The input section 506 includes a keyboard, a mouse, a microphone, an image-capturing element, and the like. The output section 507 includes a display, speakers, and the like. The recording section 508 includes a hard disk, a non-volatile memory, and the like. The communicating section 509 includes a network interface and the like. The drive 510 drives a removable recording medium 511 such as a magnetic disc, an optical disc, a magneto-optical disc, or a semiconductor memory.

In the thus-configured computer, for example, the CPU 501 loads a program recorded on the recording section 508 onto the RAM 503 via the input/output interface 505 and the bus 504 and executes the program to thereby perform the series of processing mentioned above.

The program executed by the computer (CPU 501) can be provided being recorded on the removable recording medium 511 as a package medium or the like, for example. In addition, the program can be provided via a cable transfer medium or a wireless transfer medium like a local area network, the Internet, or digital satellite broadcasting.

At the computer, by attaching the removable recording medium 511 to the drive 510, the program can be installed on the recording section 508 via the input/output interface 505. In addition, the program can be received at the communicating section 509 via a cable transfer medium or a wireless transfer medium, and installed on the recording section 508. Other than them, the program can be installed in advance on the ROM 502 or the recording section 508.

Note that the program executed by the computer may be a program that performs processes in a temporal sequence along an order explained in the present specification or may be a program that performs processes in parallel or at necessary timings such as timings when those processes are called.

In addition, embodiments of the present technology are not limited to the embodiments mentioned above but can be changed in various manners within the scope not deviating from the gist of the present technology.

For example, the present technology can be configured as cloud computing in which one functionality is shared among a plurality of apparatuses via a network and is processed by the plurality of apparatuses in cooperation with each other.

In addition, other than being executed on one apparatus, each step explained in a flowchart mentioned above can be shared and executed by a plurality of apparatuses.

Furthermore, in a case where one step includes a plurality of processes, other than being executed on one apparatus, the plurality of processes included in the one step can be shared among and executed by a plurality of apparatuses.

Furthermore, the present technology can also have a configuration like the ones below.

(1)

A signal processing apparatus including:

a selecting section that is supplied with a plurality of audio signals and selects an audio signal to be subjected to a sound quality enhancement process; and

a sound-quality-enhancement processing section that performs the sound quality enhancement process on the audio signal selected by the selecting section.

(2)

The signal processing apparatus according to (1), in which the selecting section selects the audio signal to be subjected to the sound quality enhancement process on the basis of metadata of the audio signals.

(3)

The signal processing apparatus according to (2), in which the metadata includes priority information representing priorities of the audio signals.

(4)

The signal processing apparatus according to (2) or (3), in which the metadata includes type information representing types of the audio signals.

(5)

The signal processing apparatus according to any one of (2) to (4), further including:

a metadata generating section that generates the metadata on the basis of the audio signals.

(6)

The signal processing apparatus according to any one of (1) to (5), in which, for each of the audio signal, the selecting section selects the sound quality enhancement process to be performed on the audio signal from multiple sound quality enhancement processes that are mutually different.

(7)

The signal processing apparatus according to (6), in which the sound quality enhancement process includes a dynamic range expansion process or a bandwidth expansion process.

(8)

The signal processing apparatus according to (6), in which the sound quality enhancement process includes a dynamic range expansion process or a bandwidth expansion process based on a prediction coefficient obtained by machine learning and on the audio signal.

(9)

The signal processing apparatus according to (8), further including:

a coefficient selecting section that, for each type of audio signal, retains the prediction coefficient, and selects the prediction coefficient to be used for the sound quality enhancement process from a plurality of the retained prediction coefficients on the basis of type information representing a type of the audio signal.

(10)

The signal processing apparatus according to (6), in which the sound quality enhancement process includes a bandwidth expansion process of generating a high-frequency component by linear prediction based on the audio signal.

(11)

The signal processing apparatus according to (6), in which the sound quality enhancement process includes a bandwidth expansion process of adding white noise to the audio signal.

(12)

The signal processing apparatus according to any one of (1) to (11), in which the audio signals include audio signals of channels or audio signals of audio objects.

(13)

A signal processing method performed by a signal processing apparatus, the signal processing method including:

being supplied with a plurality of audio signals, and selecting an audio signal to be subjected to a sound quality enhancement process; and

performing the sound quality enhancement process on the selected audio signal.

(14)

A program that causes a computer to execute a process including:

a step of being supplied with a plurality of audio signals, and selecting an audio signal to be subjected to a sound quality enhancement process; and

a step of performing the sound quality enhancement process on the selected audio signal.

### REFERENCE SIGNS LIST

11: Signal processing apparatus
22: Audio selecting section
23: Sound-quality-enhancement processing section
24: Renderer
25: Reproduction signal generating section
32-1 to 32-m, 32: High-load sound-quality-enhancement processing section
33-1 to 33-m, 33: Mid-load sound-quality-enhancement processing section
34-1 to 34-m, 34: Low-load sound-quality-enhancement processing section
301-1 to 301-m, 301: Coefficient selecting section
341-1 to 341-m, 341: Metadata generating section

1. A signal processing apparatus comprising:
a selecting section that is supplied with a plurality of audio signals and selects an audio signal to be subjected to a sound quality enhancement process; and
a sound-quality-enhancement processing section that performs the sound quality enhancement process on the audio signal selected by the selecting section.

2. The signal processing apparatus according to claim 1, wherein the selecting section selects the audio signal to be subjected to the sound quality enhancement process on a basis of metadata of the audio signals.

3. The signal processing apparatus according to claim 2, wherein the metadata includes priority information representing priorities of the audio signals.

4. The signal processing apparatus according to claim 2, wherein the metadata includes type information representing types of the audio signals.

5. The signal processing apparatus according to claim 2, further comprising:
a metadata generating section that generates the metadata on a basis of the audio signals.

6. The signal processing apparatus according to claim 1, wherein, for each of the audio signal, the selecting section selects the sound quality enhancement process to be performed on the audio signal from multiple sound quality enhancement processes that are mutually different.

7. The signal processing apparatus according to claim 6, wherein the sound quality enhancement process includes a dynamic range expansion process or a bandwidth expansion process.

8. The signal processing apparatus according to claim 6, wherein the sound quality enhancement process includes a dynamic range expansion process or a bandwidth expansion process based on a prediction coefficient obtained by machine learning and on the audio signal.

9. The signal processing apparatus according to claim 8, further comprising:
a coefficient selecting section that, for each type of audio signal, retains the prediction coefficient, and selects the prediction coefficient to be used for the sound quality enhancement process from a plurality of the retained prediction coefficients on a basis of type information representing a type of the audio signal.

10. The signal processing apparatus according to claim 6, wherein the sound quality enhancement process includes a bandwidth expansion process of generating a high-frequency component by linear prediction based on the audio signal.

11. The signal processing apparatus according to claim 6, wherein the sound quality enhancement process includes a bandwidth expansion process of adding white noise to the audio signal.

12. The signal processing apparatus according to claim 1, wherein the audio signals include audio signals of channels or audio signals of audio objects.

13. A signal processing method performed by a signal processing apparatus, the signal processing method comprising:
being supplied with a plurality of audio signals, and selecting an audio signal to be subjected to a sound quality enhancement process; and
performing the sound quality enhancement process on the selected audio signal.

14. A program that causes a computer to execute a process comprising:
a step of being supplied with a plurality of audio signals, and selecting an audio signal to be subjected to a sound quality enhancement process; and
a step of performing the sound quality enhancement process on the selected audio signal.
